(19) United States
(12) Patent Application Publication
(10) Pub. No.: US 2021/0192408 A1
(43) Pub. Date: Jun. 24, 2021

(54) AUTOMATED DOCKETING SYSTEM

(71) Applicant: Black Hills IP Holdings, LLC, Minneapolis, MN (US)

(72) Inventors: Steven W. Lundberg, Edina, MN (US); Thomas G. Marlow, Cape Elizabeth, ME (US); Christopher James Kinniburgh, Minneapolis, MN (US); Elliott M. Higgins, Minneaplis, MN (US)

(21) Appl. No.: 17/247,768

(22) Filed: Dec. 22, 2020

Related U.S. Application Data
(60) Provisional application No. 63/114,937, filed on Nov. 17, 2020.
(60) Provisional application No. 63/039,278, filed on Jun. 15, 2020.
(60) Provisional application No. 62/952,391, filed on Dec. 22, 2019.

(51) Int. Cl. G06Q 10/06; G06Q 50/18; G06K 9/00; G06F 40/169; G06F 40/174; G06F 40/186

(52) U.S. Cl. CPC G06Q 10/06311; G06Q 50/18; G06K 9/00442; G06K 2209/01; G06F 40/174; G06F 40/186; G06F 40/169

(57) ABSTRACT

An automated docketing system receives documents from a plurality of sources, identifies the type of document, annotates the document, and automatically processes the document based on pre-established automated procedures for the respective annotations. The automated procedures may be universal procedures that are supplemented by customer-specific procedures that are unique to a given customer. In the case of a patent docketing system, the annotations may specify, for example, a response due date, whether an Official Action is final or non-final, whether drawing corrections are needed, and the like. The annotations are then used to inform the docketing database as to what actions to take when loading the document. Other automated procedures may automatically generate reporting letters, reminders, and the like and automatically identify and attach the docket items associated with the communications. Legal file wrappers also may be downloaded and automatically broken into respective individual documents for docketing.

### CROSS-REFERENCE TO RELATED APPLICATIONS

The present application claims priority to U.S. Provisional Patent Application Ser. No. 62/952,391, filed Dec. 22, 2019, to U.S. Provisional Patent Application Ser. No. 63/039,278, filed Jun. 15, 2020, and to U.S. Provisional Patent Application Ser. No. 63/114,937, filed Nov. 17, 2020. The contents of these provisional patent applications are hereby incorporated by reference.

### TECHNICAL FIELD

This application is directed to an electronic docketing system and, more specifically, to an electronic docketing system that provides full or partial automation of docketing tasks.

### BACKGROUND

Maintaining a docketing system for managing the due dates for legal matters such as pending patent applications requires highly skilled docketing personnel to perform a plethora of manual data entry tasks. Conventional docketing software implements functionality such as auto-completion that has addressed the rote data entry tasks and the attendant data entry errors. However, classification of the documents for docket entry and the associated processing tasks for the classified documents generally remain the responsibility of the docketing personnel. It remains desirable to apply computer processing to the docketing tasks to further automate the creation and updating of dockets, particularly dockets for managing portfolios of patent applications.

### SUMMARY

Various examples are now described to introduce a selection of concepts in a simplified form that are further described below in the Detailed Description. The Summary is not intended to be used to limit the scope of the claimed subject matter.

The systems and methods described herein address the needs in the art by providing an automated docketing system that receives documents from a plurality of sources, identifies the type of document, annotates the document, and automatically processes the document based on pre-established automated procedures for the respective annotations. The automated procedures may be universal procedures that are supplemented by customer-specific procedures that are unique to a given customer. In a sample embodiment for docketing Official Actions and other correspondence received by an administrative patent docketing system, the automated docketing system receives Official Actions and other documents from government offices, patent agents, and the like, identifies the document as a Non-Final Official Action, Final Official Action, Notice of Allowability, annuity document, agent letter, and the like using automated techniques to identify the format and content of the received documents, and annotates the document. Such annotations may specify, for example, a response due date, whether an Official Action is final or non-final, whether drawing corrections are needed, and the like. The annotations are then used to inform the docketing database as to what actions to take when loading the document. For example, the annotations inform the docketing database of the due date for any response and corresponding procedure codes tell the docketing system what processes to run on the document. Once the document is so identified, the document is provided to a customer docketing system for the identified processing. Other automated procedures may automatically generate reporting letters, reminders, and the like.

In accordance with a first aspect, a method of docketing documents relating to legal matters using one or more processing devices is provided. The method includes receiving from third party sources documents relating to one or more legal matters; performing Optical Character Recognition (OCR) on at least one of the received documents and extracting identification data that relates to a document type; annotating the at least one document to provide metadata about the contents of the at least one document that may be used to identify the at least one document and to docket the at least one document in a docketing system; extracting annotations from the at least one document to complete an automated processing template including universal procedure codes for the at least one document that specify any processes to be performed on the at least one document upon receipt by the docketing system; and forwarding the at least one document and the automated processing template to the docketing system. In sample embodiments, the annotating of the at least one document includes attaching a key-value pair relating to data within the at least one document. For example, the annotations may specify a response due date, whether an Official Action is final or non-final, and/or whether drawing corrections are needed.

In sample embodiments, the at least one document may be automatically processed based on pre-established automated procedures for the respective annotations. Automatically processing the at least one document may include performing universal procedures for the at least one document once identified that are supplemented by customer-specific procedures that are unique to a given customer. Annotating the at least one document to provide metadata about the contents of the at least one document may further comprise generating annotations using a machine learning system that has been trained using a training set comprising prior document identification data.

In the sample embodiments, receiving the at least one document from third party sources comprises receiving documents from a Patent Office docketing portal, Patent Office Patent Application Information Retrieval (PAIR) files, and/or via email from a foreign agent, a law firm, or a corporate law department.

In further sample embodiments, performing OCR on the received at least one document and extracting identification data that relates to the document type comprises extracting specified data, reading checkboxes, and/or extracting lists from the received at least one document. Completing the automated processing template may further include pulling in attributes from the annotations in the at least one document.

In still further sample embodiments, forwarding the at least one document and the automated processing template to the docketing system comprises validating the received at least one document against entries in the docketing system and communicating validated documents to the docketing system. Forwarding the at least one document may also include sending a docketing report to an external verification system that uses a set of rules to verify proper docketing in the docketing system. Reporting the docketing results may further include automatically generating an automated email notification that specifies docketing processes taken on the identified document.

In other sample embodiments, the received at least one document is processed into one or more documents in portable document format (PDFs), the one or more PDFs are inserted into a zip file, and the zip file is forwarded to an OCR system to extract text and annotations from the at least one document that may be used to identify the at least one document. The at least one document may be identified by comparing a string match extracted during OCR with identifying data. When the at least one document has a string match with identifying data for more than one document type, annotation rules and verification rules may be applied to the at least one document and the annotations to uniquely identify the document type.

In the other sample embodiments, extracting identification data that relates to the document type comprises applying text extraction rules to text data generated by performing OCR on the at least one received document to extract the identification data relating to the document type. Extracting identification data may also comprise identifying checkboxes, form numbers, and phrases in the at least one received document.

In further sample embodiments, identifying the at least one document may further comprise pre-verifying the at least one document using Multidoc rules by reading the at least one document as well as any documents to which the at least one document is associated in a zip file to select phrases and to perform identification of the at least one document. Identifying the at least one document may further comprise downloading a unified rules file that provides a set of rules for how to identify and verify a document with a unique document item ID (UDOCIID), matching the at least one document against the unified rules to identify a UDOCIID for the at least one document and any associated annotations, and identifying the at least one document from the UDOCIIDs. Identifying the at least one document may further comprise applying phrase rules that generate a single query that refers to different parts of the at least one document and using Boolean logic and regular expressions to provide a UDOCIID for the at least one document where each individual element in a phrase rule evaluates to true or false.

In still further sample embodiments, annotating the at least one document to provide metadata about the contents of the at least one document comprises searching results of the OCR for particular text and/or calculating dates out of an image file wrapper XML, from the USPTO and determining if the at least one document was received within a predetermined number of days of a particular event. Annotating the at least one document to provide metadata about the contents of the at least one document may further comprise generating annotations through functions that fail immediately when the at least one document is not from a particular country or the function does not have sufficient information to calculate the annotation but that add a new annotation to the at least one document when the function succeeds.

The further sample embodiments include sending the at least one document once identified by document type back through a specialized OCR function built specifically to extract annotations for the document type of the at least one document.

In the further sample embodiments, a machine learning system may be used to test identification of the at least one document by predicting an identification of the at least one document, comparing the predicted identification to the identification determined from the annotations, and accepting the identification of the at least one document when the predicted identification is consistent with the identification determined from the annotations. A machine learning system may also be used to predict a next docket process from particular text in the at least one document that corresponds to a particular procedure code and docketing the at least one document according to the procedure code.

In accordance with a second aspect, forwarding the at least one document and the automated processing template to the docketing system includes sending the at least one document to a human docketer for making a docketing selection and verifying the docketing selection using a machine learning system that determines a machine learning score from the extracted annotations. The machine learning score may represent a percentage likelihood that an applied docketing selection is a correct choice for a document. The docketing selection by the human docketer may be forwarded to the docketing system when the machine learning score has at least a minimum value. On the other hand, a warning may be provided to the human docketer when the machine learning score is below the minimum value.

In additional sample embodiments, forwarding the at least one document and the automated processing template to the docketing system includes creating a reporting template, auto-filling the reporting template with data relating to a docketing process to be taken for the at least one document, and forwarding the reporting template to the docketing system.

In the additional sample embodiments, annotating the at least one document includes applying annotation rules. Applying the annotation rules may include using the annotation rules to fetch publicly accessible data upon which docketing decisions for a document and logic for the annotation rules may be based. The annotation rules may be written based on historical events for one or more particular type of document or based on metadata about the contents of the at least one document. Version control and version integrity may also be applied to the annotation rules to prevent regression in the annotation rules. The annotation rules also may be recursive whereby applying annotation rules that set annotations are applied before applying annotation rules that rely upon the set annotations.

In the additional sample embodiments, the at least one document may be identified using a single identifier that represents multiple associated documents. The annotation rules may further specify that a document identification and/or a procedure code for processing a document may not be assigned more than once in a given time period.

In further additional sample embodiments, forwarding the at least one document and the automated processing template to the docketing system may include sending the at least one document to the docketing system and automatically forwarding the at least one document to at least one of a designated email address and a folder of a client of the docketing system. A message to a human docketer may also be associated with each annotation rule and presented to the human docketer when the annotation rule is invoked.

In accordance with a third aspect, the method of docketing may further comprise scraping at least one web site of a third party source having docket items relating to the one or more legal matters, downloading and storing scraped docket items in a database, and providing the docket item as the at least one document for annotation. In such sample embodiments, the method further includes cross-referencing a docket item stored in the database against received communications, joining the docket item to a received communication that is matched to the docket item, and providing the joined docket item and received communication for annotation.

In additional sample embodiments, the method may further comprise scraping at least one website of a third party source having docket items relating to the one or more legal matters, downloading and storing scraped docket items in a database, enabling access to stored docket item associated with a portfolio, and generating a reporting letter having at least one of a link to or an attached copy of the stored docket item.

In the additional sample embodiments, scraping the at least one website of a third party source comprises a scraper tool changing its Internet Protocol (IP) address and user agent periodically to change its identity between scrapes and reshuffling the IP addresses and user agents for use in subsequent scrapes after a predetermined number of identities has been used.

In accordance with a fourth aspect, the received documents include a downloaded file wrapper that is received as a consolidated PDF. The downloaded document is separated into respective individual documents by assigning a bookmark in PDF to each separate individual file wrapper document in the file wrapper, extracting each individual file wrapper document from the consolidated PDF, and assigning to each extracted file wrapper document at least one of a file name or metadata. In sample embodiments, the at least one file name or metadata includes at least one of a date of the extracted file wrapper document, a serial number of the file wrapper, or name assigned to the extracted file wrapper document by a third party source of the file wrapper. The extracted file wrapper document may be further tagged with a tag describing contents of the extracted file wrapper document.

The sample embodiments, the method further includes determining whether the extracted file wrapper document is from a pending matter and, when the extracted file wrapper document is determined to be from a pending matter, tagging the extracted file wrapper document as active; otherwise tagging the extracted file wrapper document as inactive. When the received file wrapper document is determined to be inactive, the extracted file wrapper document may be mapped to a docketing template that loads an activity with a date and a name of the extracted file wrapper document but launches no due dates for the extracted file wrapper document. On the other hand, when the received file wrapper document is determined to be active, the extracted file wrapper document may be mapped to a docketing template that is used to docket documents of a type of the extracted file wrapper document in the docketing system. The extracted file wrapper document is then forwarded to a docketing system.

The methods described herein may be performed by an automated docketing system configured to implement the methods described herein. Also, the methods described herein may be implemented by instructions on computer-readable media that are processed by one or more processors of an automated docketing system. Further features of the method and instructions on the computer-readable media result from the functionality of the apparatus. Also, the explanations provided for each aspect and its implementation apply equally to the other aspects and the corresponding implementations. The different embodiments may be implemented in hardware, software, or any combination thereof. Also, any one of the foregoing examples may be combined with any one or more of the other foregoing examples to create a new embodiment within the scope of the present disclosure.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of an automated docketing system in a sample embodiment.

FIG. 2 illustrates sample third party data sources that provide docketing data input for an automated docketing system implemented for managing patent portfolios in a sample embodiment.

FIG. 3 illustrates the flow of the data from the third party into the IP Tools system for processing.

FIG. 4 illustrates the flow of data from the IP Tools system to the data extraction and annotation systems in a sample embodiment.

FIG. 5 illustrates samples of the data types that may be processed by the automated docketing system in sample embodiments.

FIG. 6A illustrates the respective components of the IP Tools system in a sample embodiment.

FIG. 6B illustrates a flow diagram of the IP Tools system in a sample embodiment.

FIG. 7 illustrates a flow diagram of the Auxiliary Annotation System (AAS) in a sample embodiment.

FIGS. 8A-8C together comprise a flow chart illustrating the rule phase logic of the AAS in a sample embodiment.

FIG. 9 illustrates the formation of the uniform universal rules sets and system specific rule sets to enable customer procedure sets to use the same naming convention for equivalent procedures in sample embodiments.

FIG. 10 illustrates combination of the uniform procedure names, customer procedure, and system code into an information stack for storage in the Universal Procedures Database.

FIG. 11 illustrates a sample universal procedure record taken from the information stack of FIG. 10.

FIG. 12 illustrates a sample screen shot of a report out template in a sample embodiment.

FIG. 13 illustrates a flow diagram of the reporting process in a sample embodiment.

FIG. 14 illustrates a flow diagram of a feature of an automated docketing system that pre-saves docket items for automated docketing in a sample embodiment.

FIG. 15 illustrates a flow diagram of a feature of an automated docketing system that pre-saves docket items for automated reporting in a sample embodiment.

FIG. 16 illustrates a method of automatically generating a group of separate file wrapper documents extracted from a legal file wrapper in sample embodiment.

FIG. 17 illustrates a method of processing “active” and “inactive” file wrapper documents in a sample embodiment.

FIG. 18 is a block diagram of a typical, general-purpose computer that may be programmed into a special purpose computer suitable for implementing one or more embodiments of the automated docketing system disclosed herein.

### DESCRIPTION

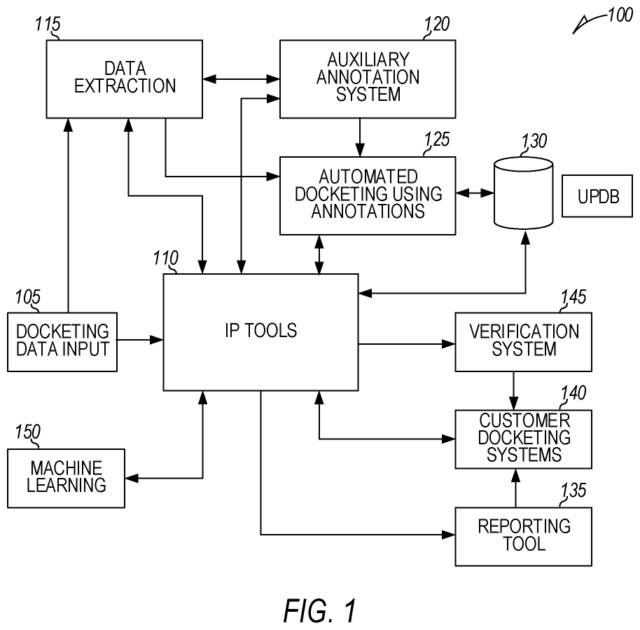

It should be understood at the outset that although an illustrative implementation of one or more embodiments are provided below, the disclosed systems and/or methods described with respect to FIGS. 1-18 may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The functions or algorithms described herein may be implemented in software in one embodiment. The software may include computer-executable instructions stored on computer-readable media or computer-readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, application specific integrated circuit (ASIC), microprocessor, or other type of processor operating on a computer system, such as a personal computer, server or other computer system, turning such computer system into a specifically programmed machine.

### Terminology

As used herein, “annotation” refers to a key-value pair attached to a document. The annotation has a ‘title’ and a ‘value’. Annotations are used to provide metadata about documents. For example, annotations may be used to provide information on dates, data that is pulled from other sources, and a variety of other pieces of metadata about the document. In the case of an annotation containing the mail room date of a document, an annotation might include a title like ‘MailRoomDate’ and a value of ‘07-03-2018’. On the other hand, a Boolean annotation for whether the inventor data on the document matches the Patent Application Information Retrieval (PAIR) inventors list may be provided. In that case, the annotation title might be ‘InventorsMatch’ and the values might be either ‘True’ or ‘False’. In the annotations, all titles and all values are strings. However, not all documents have all annotations. For example, in the ‘InventorsMatch’ example, if PAIR data for a matter is unavailable, an ‘InventorsMatch’ annotation for the document is not created unless there is enough information to say one way or another whether there is a match. The document annotations include values that can be read from one system to another. Having values that can be read from one system to another also makes storing document annotation data in an export spreadsheet quite simple. Columns may be provided for each unique annotation across all documents being exported.

### Overview

The automated docketing system described herein receives documents from a plurality of sources, identifies the type of document, annotates the document, and automatically processes the document based on pre-established automated procedures for the respective annotations. The automated procedures may be universal procedures that are supplemented by customer-specific procedures that are unique to a given customer. By way of example, an embodiment is described for docketing Official Actions and other correspondence received by an administrative patent docketing system. In such an embodiment, the automated docketing system receives Official Actions and other documents from government offices, patent agents, and the like, identifies the document as a Non-Final Official Action, Final Official Action, Notice of Allowability, annuity document, agent letter, and the like using automated techniques to identify the format and content of the received documents, and annotates the document. Such annotations may specify, for example, a response due date, whether an Official Action is final or non-final, whether drawing corrections are needed, and the like. The annotations are then used to inform the docketing database as to what actions to take when loading the document. For example, the annotations inform the docketing database of the due date for any response and corresponding procedure codes tell the docketing system what processes to run on the document. Once the document is so identified, the document is provided to a customer docketing system for the identified processing. Other automated procedures may automatically generate reporting letters, reminders, and the like.

### Automated Docketing System

FIG. 1 is a block diagram of an automated docketing system 100 in a sample embodiment. As illustrated, the automated docketing system 100 receives documents from third party sources including third party docketing systems and/or customer data as docketing data input 105. An IP Tools system 110 processes the received documents to provide to the customer docketing systems 140 and prepares the documents for data extraction by data extraction system 115 as needed. The data extraction system 115 performs Optical Character Recognition (OCR) on the received documents from the IP Tools system 110 to extract data, read checkboxes, extract lists, and identify documents where possible. The IP Tools system 110 also integrates with a Universal Procedures Database (UPDB) 130 to provide automated docketing by an automated docketing tool 125 that processes received documents based on the additional annotations added to the documents based on the complex data extraction performed by the Auxiliary Annotation System (AAS) 120. As will be elaborated upon below, the AAS 120 may further identify the received documents without using an OCR. To manage this process, the IP Tools system 110 receives frequent updates of docketing procedure rules including configuration data and updates the UPDB 130 with universal procedure codes (UPCs) as appropriate. The UPCs are used in conjunction with customer specific codes, checklists, and templates. The rules specify how to fill in the templates and how to complete customer-specific procedures such as how to docket documents into the customer's docketing system 140, for example. The template is completed by pulling in attributes from the annotations in a document.

The IP Tools system 110 receives/intakes documents and docketing data from several different sources of docketing data input 105, validates the docketing items against entries in a customer's docketing system 140, and communicates those documents to the customer's docketing system 140 via a unified interface. The IP Tools system 110 also routes documents and associated docketing data through the data extraction system 115 and the AAS 120 and organizes the returned metadata and annotations. The IP Tools system 110 thus provides a breakout between the metadata and the document text. The IP Tools system 110 also keeps records and communicates with third-party application programming interfaces (APIs) to push the docketing data and documents automatically where allowed. Otherwise, the IP Tools system 110 presents the documents to human docketers to docket. The IP Tools system 110 may also issue reports upon request.

The IP Tools system 110 may be integrated with a customer's existing docketing system (e.g., Foundation IP), semi-integrated (e.g., CPI, Anaqua, etc.), may provide a virtual host that does not talk at all to the customer's existing docketing system (e.g., Lecopio, IP Manager, Memotech), or may provide outputs in spreadsheet form for use by a docketing administrator to update the customer's docking system 140. If the IP Tools system 110 and the customer's docketing system are not integrated, the data output of automated docketing system 100 may be presented to a human docketer for manual entry. In sample embodiments, the human docketer may implement macros that interface with the customer's docketing system 140 to populate the received data into the customer's docketing system 140. On the other hand, if the IP Tools system 110 and the customer's docketing system 140 are integrated or semi-integrated, the data output may be processed to determine if any data is missing to automate the docketing process. If anything is missing, the human docketer may add that information before the automated docketing process may proceed further or the data may be auto-populated and mapped to the template from the UPDB 130.

The automated docketing system 100 also performs several post docketing actions including send docketing reports/details to an external verification system 145 that uses a set of rules to verify proper docketing in a host system. The verification system 145 verifies that the data is correctly added to the external customer's docketing system 140. For example, the verification system 145 pulls data from the AAS 120, the IP Tools system 110, and the customer's docketing system 140 to compare what is present to what is expected to be present in the respective systems.

The automated docketing system 100 may also provide automated email “report out” notifications to customers by implementing a reporting tool 135 that specifies docketing actions based on UPDB template configurations. Reporting tool 135 may also provide completed docketing reports to customers either directly or via the customers' docketing system 140.

In sample embodiments, machine learning techniques may be used to generate annotations. For example, a database of past documents that have been identified may be provided by the IP Tools system 110 and used as a data warehouse to train and improve machine learning models by creating a training set for the machine learning model. Over time, the machine learning model system 150 will learn which PTO IDs to use for which documents, which document in a bundle of documents may be used to characterize the bundle, and may provide predicted PTO IDs for the received documents. The machine learning model system 150 may also establish rule engine prediction capabilities for received documents that test the classifications.

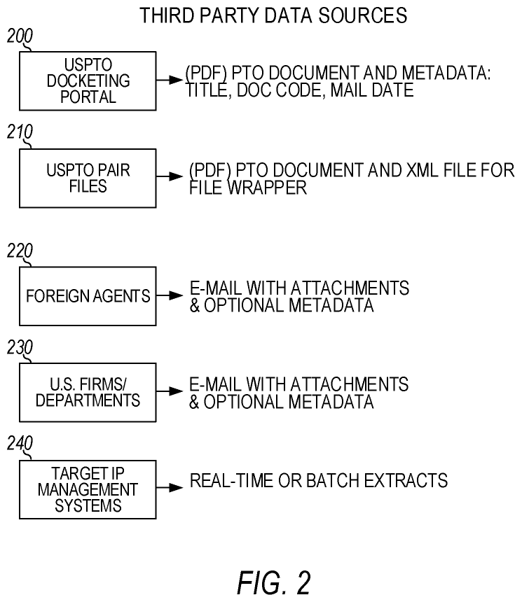

FIG. 2 illustrates sample third party data sources that provide docketing data input 105 for an automated docketing system 100 implemented for managing patent portfolios in a sample embodiment. As illustrated in FIG. 2, the third party data sources may include the Patent Office (e.g., USPTO) docketing portal 200, which provides documents from the USPTO in portable document format (PDF) and includes metadata identifying the title, document code, and mail date for the corresponding document. The third party data sources may further include USPTO PAIR extensible markup language (XML) files 210, which provide documents from the USPTO in PDF and includes an XML, file for patent file wrappers. The third party data sources may also include foreign agents 220 who provide emails with attachments and optional metadata. Foreign agents 220 may also provide hard copy documents that may be scanned for data entry. Similarly, law firms and/or corporate law departments 230 may provide emails with attachments and optional metadata as well as hard copy documents that may be scanned for data entry. Also, third party docketing systems 240 may provide real-time or batch extracts of data for entry into a docketing management system.

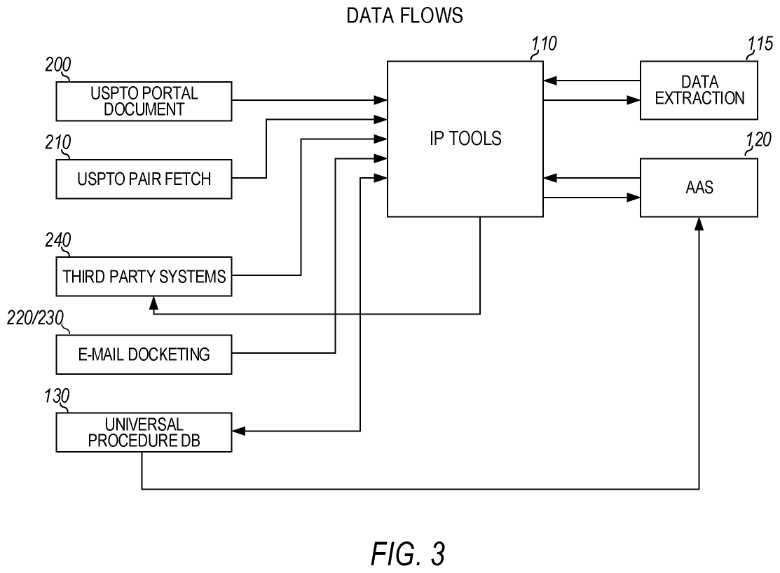

FIG. 3 illustrates the flow of the data from the third party into the IP Tools system 110 for processing. As illustrated, documents from the USPTO portal 200 that are downloaded for docketing, USPTO PAIR XML files 210 that are fetched for docketing, customer data fetched from third party docketing system 240, and docketing materials received manually or via email from foreign agents 220 or law firms or corporate law departments 230 are input into IP Tools system 110 for processing. UPDB 130 provides docketing procedures updated regularly (e.g., daily) that are implemented using universal procedure codes (UPCs). As noted above, the UPCs are used in conjunction with customer specific codes, checklists, and templates to implement rules corresponding to action codes of the customer's docketing system 140 specifying how to fill in the templates and how to complete customer-specific procedures such as how to docket documents into the customer's docketing system 140. The received documents are processed into PDFs, inserted into zip files, and forwarded to data extraction system 115, which extracts relevant text and annotations from the documents. The documents and the extracted text and annotations are provided to AAS 120 that, in turn, provides additional annotations using the UPCs provided by the UPDB 130. The annotated documents are then pushed by the IP Tools system 110 into the third party docketing system 240 (including the customer's docketing system 140) either automatically or manually by the user/operator based on the degree of integration between the third party docketing system 240 and the automated docketing system 100.

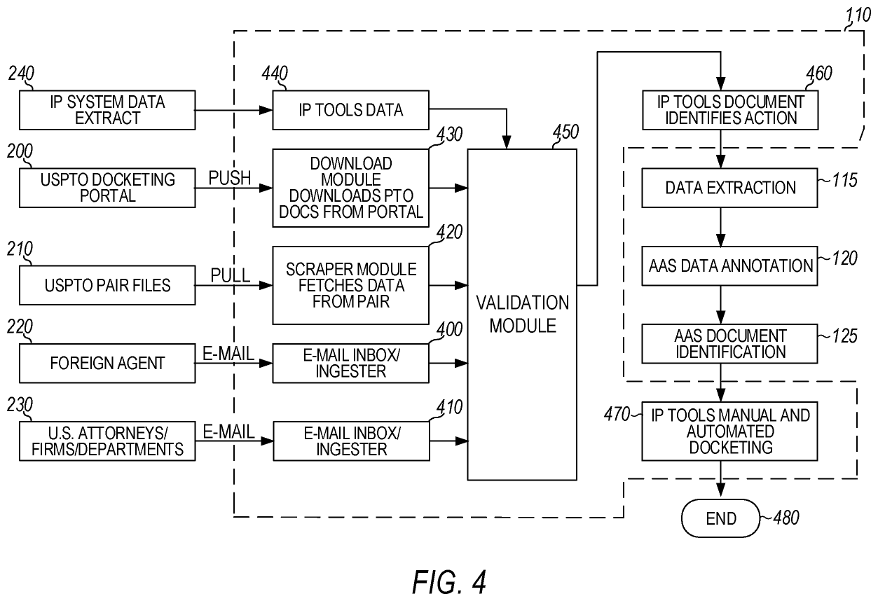

As illustrated in FIG. 4, the IP Tools system 110 includes email inbox/ingesters 400 and 410 that receive documents from the foreign agents 220 and law firms and corporate law departments 230 as well as a scraper module 420 that fetches data from the USPTO PAIR XML files 210. In sample embodiments, the scraper module 420 works by receiving requests via an HTTP GET request with two parameters stored in JavaScript Object Notation (JSON): the Country, and the Serial Number. With that data, the scraper module 420 looks up whether it knows how to grab public data for the particular country from that country's Patent and Trademark Office. If the scraper module 420 does not know how to grab the public data, it returns an error message letting the API consumer know that the scraper module 420 does not currently support that particular country. On the other hand, if the scraper module 420 does know how to scrape for that country, it downloads a series of web pages, where document and bibliographic data is stored. The scraper module 420 further downloads those pages, and parses the pages ‘DOM’—Document Object Model—so that it can understand the page. Once the page is parsed, the scraper module 420 iterates through tables and grabs relevant data based on hard-coded rules about where on each page, for each country, bibliographic and document information exists. For documents, the scraper module 420 pulls document codes, dates, titles, and any IDs. For bibliographic data, the scraper module 420 can pull address information and status information. Sometimes bibliographic status information can be inferred via events and documents, such as a grant document enabling the inference for a granted status. With all the information collected from a particular country's PTO, the scraper module 420 returns a JSON body to the API consumer, with all the data it managed to find.

The IP Tools system 110 may also include a download module 430 that downloads USPTO documents from the USPTO docketing portal 200. Also, the IP Tools system 110 may extract IP Tools data 440 from third party docketing systems 240 that are external to or a part of the automated docketing system 100. The received data is processed by validation module 450 into a common PDF and inserted into zip files for further processing. The validation module 450 also may validate received docketing items against entries in a customer's docketing system 140. In some embodiments, the document received by the IP Tools system 110 may identify via metadata, etc., the action that is to be taken on that document. In such as case, the IP Tools system 110 may identify the action at operation 460.

As will be described in further detail below, the zip file containing the documents in common PDF are forwarded to the data extraction system 115 for extracting data that may be used to classify and process the received documents using conventional Optical Character Recognition (OCR) techniques. The document is then annotated by AAS 120, and the document is identified and classified by the automated docketing tool 125. The identified and classified document is returned to IP Tools system 110 to provide to the third party docketing systems 240 for manual and automated docketing at operation 470. The process ends at 480.

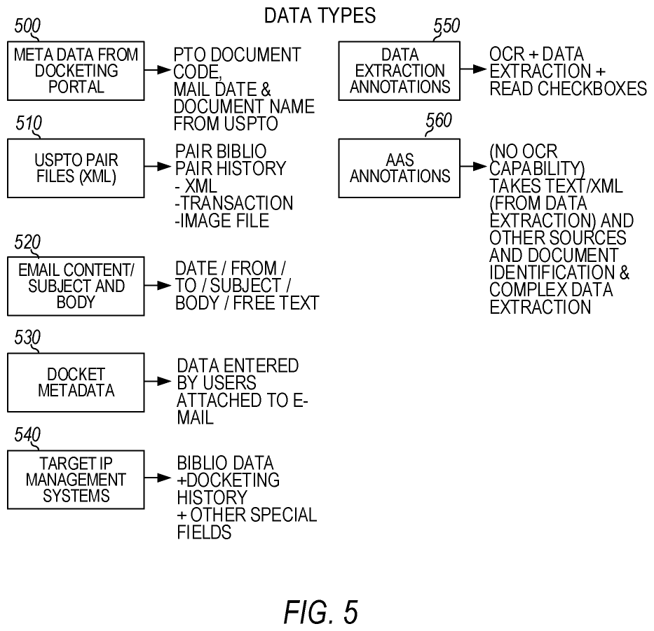

FIG. 5 illustrates samples of the data types that may be processed by the automated docketing system 100 in sample embodiments. The metadata 500 from the USPTO docketing portal may include, for example, the PTO document code, the mail date, and the document name from the USPTO. On the other hand, the USPTO PAIR files 510 may include the PAIR bibliographic data and PAIR history data in XML, as well as transaction and image files. The emailed content 520 from the foreign agents or law firms/corporate law departments may include, for example, the date, to/from data, a subject, a body, and free form text. In sample embodiments, the email data may have a standardized format as described in related U.S. patent application Ser. No. 17/097,233, filed Nov. 13, 2020, entitled “Structured Text for Electronic Communications,” the contents of which are hereby incorporated by reference. The data types may also include docket metadata 530 that has been entered by users and attached to reporting emails. The data 540 from target IP management systems may include bibliographic data and docketing history as well as other special fields.

The extracted annotation data 550 may include OCR data including data extracted from the OCR data as well as any read checkboxes. The extracted annotation data 550 also may include any desired information that can be extracted from the received document. The AAS annotation data 560 takes the text and XML, data from the data extraction system 115 and other sources and provides document identification and other complex data extraction that is provided to the IP Tools system 110 for establishing the docketing processing to be performed on the corresponding document.

In sample embodiments, the document identification and other complex data extraction provided by the AAS 120 includes application of annotation rules for annotating the documents received from the data extraction system 115. For example, the annotation rules may be associated with the received documents and used to fetch publicly accessible data upon which docketing decisions for the received document may be based. The public data may also be used to write additional logic for the annotation rules. The annotation rules may be created and iterated using an Entity-Component-System design for handling rules. In the sample embodiments, a Syntax—General [XXX](YYY=ZZZ) style syntax may be used to make the annotation rules easy to write and to integrate into the automated docketing system.

In other sample embodiments, the AAS 120 may search for historical events and implement annotation rules based on the historical events. For example, the AAS 120 may conduct a search of the host computer's history to contextualize the document history for documents analyzed by the AAS 120 to identify and to write annotation rules that incorporate past events for particular document types. This process may involve processing codes of the type described below.

In yet other sample embodiments, the AAS 120 may pull data from a system of the type described in related U.S. patent application Ser. No. 17/097,233 referenced above. Such a system enables building annotation rules based on metadata provided by the electronic communication system described therein.

In still further sample embodiments, fast updating of the annotation rules may be provided with version control and version integrity. By providing version control and version integrity for the annotation rules, the annotation rule changes may go live as they are written. Providing version control and version integrity further enables verification of the quality of new annotation rules to ensure that they do not break existing rules and to ensure that a substantial set of annotation rules are not deleted accidentally. Also, versioning prevents regression in the annotation rules. If annotation rules fail after changes and deletions, then the annotation rules may revert to a version that does not fail before any changes may be adopted.

In addition, the annotation rules may be recursive to ensure that the annotation rules that set annotations run before rules that rely on those annotations. For example, the document may be reanalyzed after an analysis by the AAS 120. The annotations may be updated with new rules and the rules updated until a final state is achieved.

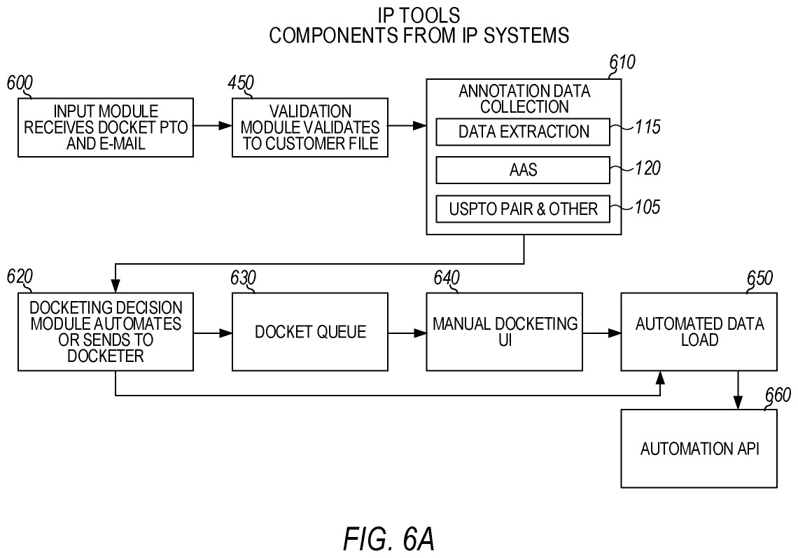

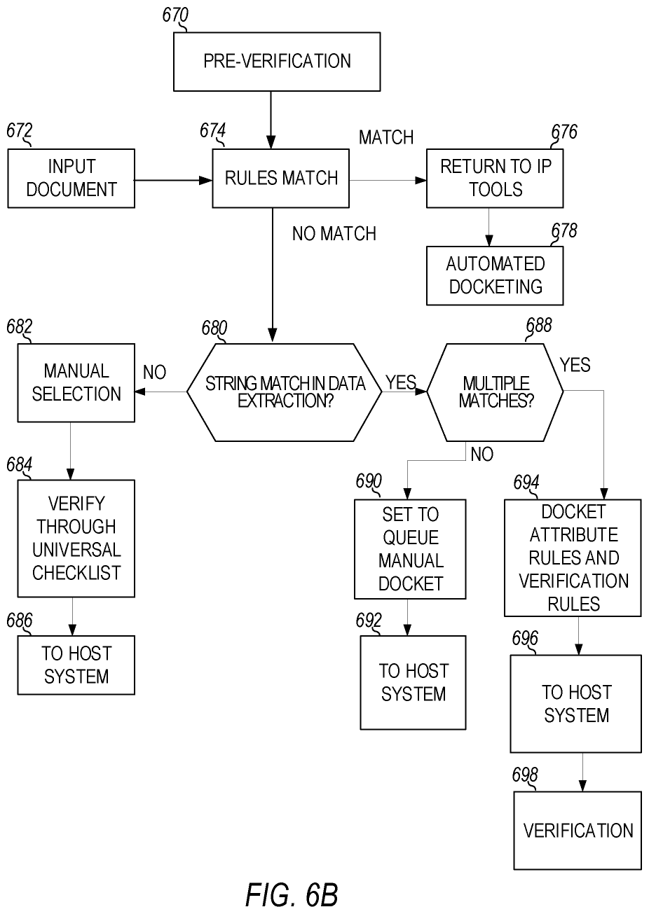

FIG. 6A illustrates the respective components of the IP Tools system 110. As illustrated, the IP Tools system 110 includes an input module 600 that receives docket data from the USPTO as well as email and other electronic communications from foreign agents, law firms and corporate law departments. The validation module 450 validates the received data to customer files and formats the received data as appropriate for further processing. The annotation data collection module 610 receives annotation data from the data extraction system 115, the AAS 120, as well as metadata from the USPTO PAIR and other data. The annotation data is provided to a docketing decision module 620 that automates the docketing data entry when the customer's docketing system 140 is integrated or semi-integrated into the automated docketing system 100. On the other hand, when the customer's docketing system 140 is not integrated or semi-integrated into the automated docketing system 100, the annotation data may be sent (e.g., as a spreadsheet) to the human docketer for further processing. The docketing tasks are placed into a docket queue 630 and provided to a manual docketing user interface 640 for further processing by the human docketers or are provided directly to the automated data loading system 650 for loading into the customer's docketing system 140 via an automation application programming interface (API) 660.

FIG. 6B illustrates a flow diagram of the IP Tools system 110 in a sample embodiment. As illustrated, the IP Tools system 110 receives pre-verified data 670 and/or input documents 672 that are formatted, as necessary, and sent to the AAS 120 to determine at operation 674 if there is a match of the extracted data to a rule set from the UPDB 130. If there is a match, the document and its annotations are returned to the IP Tools system 110 at operation 676 for commencement of automated docketing at operation 678.

On the other hand, if there is no rules match at operation 674, the document is processed at operation 680 and sent to the data extraction system 115 to determine if the input document has any string matches with identifying data for classifying the document. If not, the document cannot be classified and is returned for manual selection at operation 682. In this case, a human docketer evaluates the document against the universal checklist for documents to verify the system code and customer UPC for a particular document form at operation 684, and the results are forwarded to the customer's docketing system 140 at operation 686.

On the hand, if the input document has a string match with identifying data for classifying the document at operation 680, the input document is further evaluated at 688 to determine if the document can be uniquely classified or if the document matches multiple templates. If the input document only matches a single template, the document is sent to a queue for manual docketing entry at operation 690 and the results are forwarded to the customer's docketing system 140 at operation 692.

If the input document has a string match with multiple templates at operation 688, the annotation rules and verification rules are docketed at operation 694 by, for example, chaining procedures the customer has identified. Once the document type is uniquely identified, the results are docketed to the customer's docketing system 140 at operation 696. The results are provided to verification system 145 for verification at operation 698. Multiple different documents also may be funneled to a single PTO-ID identifying a document from the PTO or an identified procedure. Chaining then may be used to present a human docketer with multiple options to choose from when docketing one or more of the documents in the funnel. For example, a chain of documents might include sending instructions to an agent, an agent acknowledgement, an agent confirmation, an agent response including a number of files, a filing receipt, a power of attorney, a request for examination, etc. The corresponding bibliographic data could provide the serial number and filing date for the application, and a pilot procedure may be called to point to a particular filing procedure that may include multiple procedures for the chain of documents. As another example, a voluntary amendment may be chained to a divisional patent application using the host bibliographic data for an application identified by serial number and filing date.

As noted above, the docketing data input 105 may comprise data from document sources such as a data scrape from the USPTO's PAIR system that are provided to an email queue in the IP Tools system 110. The scraped data may include free text data, PDF data, WORD data, XML from PAIR including transaction history, etc., metadata, and the like. In sample embodiments, before the documents are input into the IP Tools system 110, the automated docketing system 100 uses PAIR data rules through Extensible Mark-up Language (XML) to pre-verify the document. This allows the automated docketing system 100 to use its own document verification rules to instruct automated processes how to decide which of the UPCs to use as the UPCs are tied into the customer system code and checklists. If the automation identifies the UPCs, then the documents may simply be auto-docketed into the customer's existing document system with verification afterwards. The verification may be performed once per day (batch verification) or contemporaneously.

The IP Tools system 110 also handles processing and coordination of several pre-docketing steps including breaking apart and converting the file types (bookmarked PDF files, ZIP files, Word, Excel, image formats, etc.) into single PDF documents that are provided to the data extraction system 115 for data extraction. For example, the IP Tools system 110 may scan documents received as email attachments and scan the email itself. The resulting PDFs may be provided to the data extraction system 115 in a zip file. On the other hand, any docketing data input that is already a single PDF document may be provided directly to the data extraction system 115 for data extraction.

Data extraction system 115 adds an optical character recognition (OCR)/text layer to the received PDF files and applies text extraction rules to extract data. In a sample embodiment, data extraction system 115 identifies checkboxes, form numbers, and phrases in the received documents. The data extraction system 115 also may comprise a data capture and natural language processing system such as a Abbyy's FlexiCapture OCR tool that processes the received documents using natural language processing (NLP) technology to extract data from PDFs to classify the type of document, including images, using deep learning Convolutional Neural Networks to sort documents by appearance or pattern and to classify text using statistical and semantic text analysis. Users train the FlexiCapture tool to process flexible or irregular document layouts while the administrator retains control to edit or discard auto-learning results. For example, Abbyy's FlexiCapture tool may identify 99% of Non-Final Office Actions by check boxes on page two of a United States Official Action, finding USPTO document code US-85, and auto-filling a customer's systems template with things like the tasks, due dates, etc. On the other hand, the FlexiCapture tool may identify the phrase “THIS ACTION IS MADE FINAL” in the text to establish that an Official Action is a Final Rejection. If the data/customer system template does not have an attribute that fills in that data, the automated docketing system 100 can make up ad hoc attributes for automatic entry into the customer's docketing system. The data extraction system 115 produces an annotation file that includes annotations generated by the FlexiCapture tool. The annotation data may be structured as a multi-page PDF or multiple documents in one PDF (e.g., bookmarked PDFs).

In sample embodiments, Abbyy's FlexiCapture tool may take a primary template and add an additional procedure. For example, an additional activity may be added to an issue notification. If Abbyy's FlexiCapture tool does not identify the docketing procedure, the document may be manually entered into IP Tools system 110. The document is then docketed with web services if integrated so it should generate itself.

The received documents are compared against the known document layouts to automatically identify the document by type and to automatically extract structured and unstructured data from the document. A verification system 145 (FIG. 1) allows the administrator to check that the extracted fields match the fields of the original document. The extracted data may be exported to the customer's docketing system 140 in a variety of file formats or, as in the illustrated embodiment, be forwarded to AAS 120 to produce document metadata and annotations.

In sample embodiments, a manual docketing choice may be verified with a machine learning score provided by the machine learning model system 150. For example, the automated docketing system 100 may attempt to identify a document automatically using explicit annotation rules and, if it does, it may assign the document type automatically to the document in question. Note that there is no percentage map score, as identification is binary—either it is or is not identified. However, if a human docketer elects not to use the automatic identification described herein and instead performs a manual identification of the document type (PTO-ID) for a document they seek to docket, the automated docketing system may still process the document to generate a machine learning (ML) score for the document. The generated ML score would be a percentage likelihood that one or more labels or tags are the correct choice for a document. These scores may be provided to the human docketer via the human docketer's dashboard/interface to enable the human docketer to decide whether to keep the manually assigned PTO-ID or to assign a new PTO-ID based on the ML score. Conversely, the human docketer may be given the opportunity to second guess the assigned PTO-ID and to manually change the assigned PTO-ID. Optionally, a minimum ML score may be used for the human docketer's choice to be accepted by the automated docketing system without question. As another option, if a minimum ML score is not achieved, the human docketer may receive a warning and be provided with an opportunity to change the choice. The ML score thus may be used to provide an on-the-fly confirmation of the human docketer's choice by determining if the manual choice is feasible and, if so, how accurate the manual choice may be.

As appropriate, auxiliary annotation system (AAS) 120 may provide additional text extraction rules to produce the document metadata and annotations that are customized to the particular application and/or customer. The document with the document metadata and annotations is further processed by the IP Tools system 110 to identify the information required by the customer's docketing system 140. The information required by the customer's docketing system 140 is provided through an interface to load the customer docketing system data (bibliography, docketing history, personnel) via a real-time API or through daily file loads. In sample embodiments, the AAS 120 receives host application details and docketing history, USPTO bibliographic details (if applicable), PDF documents, extracted PDF text layers, and IP Tools system 110 and FlexiCapture data extraction metadata and annotations. The AAS 120 processes these inputs to identify checkboxes, form numbers, and phrases, and to provide additional metadata and annotations and docketing instructions in the form of procedure rules to execute/follow. These docketing instructions may then be processed by the IP Tools system 110 for automation of the docketing process. A mechanism call “Multidoc” rules pre-verifies a document by reading the document as well as the documents to which it is associated in a zip file to select phrases and to perform classification of the document. The AAS 120 may extract form numbers, phrases from agent communications, and PCT documents to assist with the classification. The annotations are provided to the IP Tools system 110, which may create an activity to load a procedure including data and text attributes associated with a template in the customer's docketing system 140 and push the activity to the customer's docketing system 140. The AAS 120 thus reviews a received document, identifies it, copies, saves, and sends the document back to the IP Tools system 110, which in turn forward the document to the customer's docketing system 140 for docketing.

The AAS 120 applies a database of rules to the text and the FlexiCapture annotations, XML, annotations and past history of final docketing notices to provide a classification of the received document. In the case of multiple documents received in a single correspondence (e.g., agent emails enclosing letters and corresponding documents), the respective documents may be tagged and separately classified by the AAS 120 for separate processing. For example, the documents may be tagged for express docket processing. As an example, documents from the USPTO may be docketed in a fully automated fashion using express docketing, while foreign originated documents such as an agent letter including a copy of a formal document may be tagged for separate processing. A message, for example in the form of a short form checklist, may be provided to the human docketer for such documents to enable the separate processing. The AAS 120 may also tell the data extraction system 115 what to look for in a document and where to search by recognizing the layout patterns for different types of documents.

The annotations from the AAS 120 are pushed to a matter in the IP Tools system 110 based on the determined application serial number in accordance with the bibliographic information available in IP Tools system 110. The annotations may include a history of procedures with associated tasks and action data. In sample embodiments, the AAS 120 may also include a dashboard that provides a view into the activity of the AAS 120. The dashboard would enable the user to view the document with the proposed annotations to periodically assess the accuracy of the annotations applied to the input documents.

For automated docketing, the automated docketing tool 125 uses configuration details contained in the docketing procedure rules from UPDB 130 to define, validate, and properly docket, documents into host systems via real-time API or define actions for manual docketing completion. The UPDB 130 includes universal docketing procedure names and a code table for each customer. The UPDB 130 is thus configured to provide a common rule set as well as a set of rules that are unique to the customer. The docketing procedures (e.g., to whom to report the received document) are presented as rules for processing the document identified by a document ID that is, in turn, associated with one or more procedures by mapping the procedure to the document ID in a template. In sample embodiments, the rules are implemented as scripts. Some codes are normalized, while others may be unique to a particular customer. In other words, some procedures may be the same across customers while other procedures are different for different customers. The procedures are accordingly stored in the UPDB 130. In sample embodiments, the input document is identified and the annotations are used to determine what docketing procedure code (pcode) to apply to the document, including what information is to be docketed. One procedure code is applied to each type of document and is the same across the customers for that document type. The procedure code tells the IP Tools system 110 which checklist from the UPDB 130 to implement for that document. The fields of the checklist that are completed are based on the customer template in accordance with the requirements of the customer's docketing system 140. For example, whenever the received document is recognized to be a Non-Final rejection from the USPTO, that document can be processed the same way each time to extract the pertinent docketing information such as date of issue, due date, whether drawing corrections are required, and the like. In the case of manual docketing completion, the configuration details contained in the docketing procedure rules from the UPDB 130 are provided with the file as instructions to define, validate, and provide instructions to an administrator for manual docketing.

The automated docketing tool 125 queues the documents for a human docketer that checks the document before submitting the document to the customer's docketing system 140. The automated docketing tool 125 also identifies any missing information that the data extraction system 115 or AAS 120 could not fill in and, as possible, fills in any missing attribute information based on a customer template, which is docketing system dependent. The annotations are thus used to fill in attributes (e.g., mail date, received date, etc.) within the IP Tools system 110. The human docketer may use a universal procedure checklist and docket manually. The automated docketing system may also close activities if it knows what activities to close. For example, a spreadsheet may be generated for activities due through a given date provided to the IP Tools system 110. Checklist items may be correlated to customers and automated tasks.

### Auxiliary Annotation System (AAS)

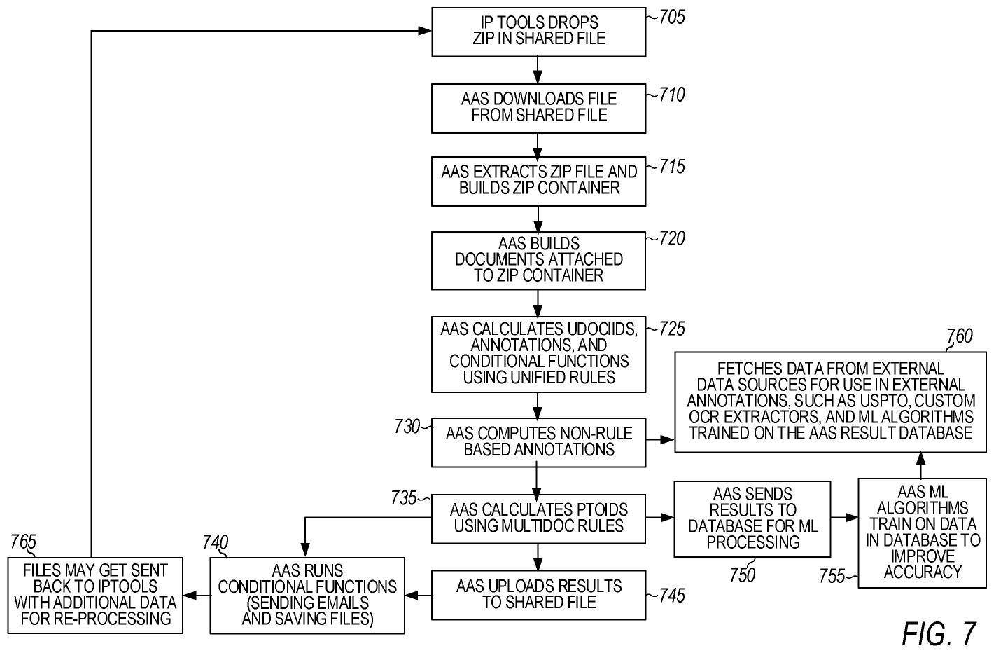

FIG. 7 illustrates a flow diagram 700 of the AAS 120 in a sample embodiment. The AAS 120 is an always-on system that lives in the cloud in sample embodiments. The main goal of the AAS 120 is to take data about recently received emails and documents, categorize them, and annotate them with additional information for future processing. As illustrated in FIG. 7, the AAS 120 may receive as input at operation 705 a zip container or a document from IP Tools system 110 or data extraction system 115. The zip container is an object containing data about the contents of a zip file from IP Tools system 110. On the other hand, the document may be an object containing the data about the body of the email creating the zip container, or the data about each PDF attachment on the email creating the zip container. A zip container can have many documents.

IP Tools system 110 generates zip files when new emails and documents come into the various inboxes described above. These zip files contain PDFs of each attachment, OCRed copies of each attachment, the body of the email, metadata IP Tools system 110 knows about the matter the email is associated with, and bibliographic data from the matter the email is associated with from the customer's docketing system 140. At specified time intervals (e.g., every minute), the AAS 120 looks in a watch folder of a file sharing service for new files for download at operation 710. If there are any files in the watch folder, AAS 120 processes them in chunks (e.g., twenty at a time). When the AAS 120 processes a chunk of files, it goes through a few main steps, including:

1. The AAS 120 reads through the files contained in each zip container.

2. The AAS 120 attempts to identify the contents of each document within each zip container.

3. The AAS 120 attempts to annotate the contents of each document within each zip container with one or more annotations like “US Entity Status,” “Final Rejection,” etc.

4. The AAS 120 runs any conditional functions for each document within the zip container.

5. The AAS 120 generates an Excel file with its results, and stores that to a file sharing service.

These steps will be elaborated upon below.

1. Reading Through the Files Contained within Each Zip Container

A number of key pieces of data is identified in each zip file. An XML file is extracted, if it exists. A ‘HostBiblio.json’ data file is extracted, if it exists. This data file contains bibliographic data from the customer's docketing system. An ‘IPToolsHistory.json’ data file is extracted, if it exists. This data file contains data about what has happened to this matter in the past, and how it has previously been identified. A ‘HostHistory.json’ data file is extracted, if it exists. This data file contains data about what has happened to this matter in the past, according to the customer's docketing system.

A series of files with filenames ending in ‘_[a number]’ is also extracted. These are the OCRed document files, and the text of the email. These get turned into documents (described below), which belong to the zip file. The party that sent the email triggering this event is also extracted and included as part of the zip container.

The AAS 120 extracts the zip file and builds a zip container at operation 715. While the zip container is being generated at operation 715, a group of documents from the OCRed PDF attachments and from the body of the email is built at operation 720. These individual documents are what the AAS 120 does most of its work on. These documents are what the AAS 120 annotates and identifies. Each document is presented as a row in the final Excel spreadsheet output.

The documents may have many annotations. The annotations are used both for identifying documents and for doing automated docketing by systems outside of the AAS 120. Anything useful that is known or can be determined about a document can be added as an annotation, and the architecture of the AAS 120 is built around the ease of turning around new annotations in less than a couple of hours. When initializing a document, the host bibliographic data is set as an annotation.

Some particular information that becomes useful relative to various rules is also extracted. For example:

Title: When generating documents, the first line of the OCR is extracted as the title.

Country: The country is extracted from the host bibliographic data if available, or from scanning the OCR for a clear indication of the country.

Mailing Date: A mailing date is received as part of the OCR and is extracted directly from the OCR.

Identification: An application number identifier comes as part of the document's filename.

DocID: This is an IP Tools internal document number that comes as part of the document's filename.

### 2. Identifying Documents

Once the zip files and the documents have been generated at operations 715 and 720, the AAS 120 begins working on identifying each document by calculating the Unique Document Item IDs (UDOCIIDs), providing annotations, and applying conditional functions using Unified Rules at operation 725. At operation 725, the AAS 120 first goes through each document and attempts to ‘identify the document’ in the context of just the document itself.

To identify the document in the context of the document itself, the AAS 120 downloads the ‘Unified Rules.xlsx’ file from the shared storage. The Unified Rules file is a shared documents file generated through the UPDB 130 that provides a set of rules for how to identify and verify a document with a UDOCIID. Each document is matched against the Unified Rules to identify a PTO document code as well as any user defined annotations. Each document can have many UDOCIIDs, and they serve as a first pass for identifying the document. There are many ways to identify a document as being a UDOCIID with the Unified Rules. First, a list of relevant rules to the document is obtained. These are rules where the document's country matches the rule's country column, or the rule's country column is a catchall. Then, the AAS 120 runs through ‘doc_title_rules,’ ‘doc_code_rules,’ and ‘phrase rules.’

### Doc_Title Rules

Doc_Title rules are simple rules that just match on a title. When identifying a UDOCIID by Doc_Title rules, if the title of the document matches the title on the rule, the rule's UDOCIID is assigned unless the rule would assign ‘DO NOT ASSIGN ID’ to the UDOCIID.

### Doc_Code Rules

Doc_Code rules are a little more complicated. They attempt to identify a document based on a form number that will be found on an OCRed document. First, the AAS 120 looks at the ‘PTO Document Code’ column and takes that as a document code. This document code is prefixed with something depending on the document's country. For example, for Europe, a document may be prefixed with ‘epoform’, while for China, a document may be prefixed with ‘CNForm’, and for the US, a document may be prefixed with ‘DocCode,’ etc. Before seeing if the document code is within the OCR, a remove function is performed to remove any text listed in the rule's ‘Remove’ column. Rule writers can use a ‘+’ to separate multiple things for removal from the remove function (for example, instances of the word cat or dog could be removed from the OCR before running the DocCode rule by adding ‘cat+dog’ to the remove column). If, after executing the remove function, the prefix and the PTO Document Code are found, the document is identified with the rule's UDOCIID.

### Phrase Rules

Phrase rules are by far the most complex rule type. The phrase rules allow rule writers to generate a single complex query that can refer to lots of different parts of the document (such as the OCR text and annotations), use Boolean logic, and regular expressions to provide a unique ID for each document. Phrase rules are a string with the following syntax:

‘&’ is an AND

‘+’ is an OR

‘!’ is a NOT

Each individual element in a phrase rule evaluates to true or false.

If a phrase element begins with [ann] it does an annotation comparison. [ann] is a way of identifying that the phrase is to be checked using the annotation search functionality. This phase element expects a format like [ann] annotation_name=annotation_value or [ann]annotation_name!=annotation_value. ‘True’ is returned if the document has an annotation named annotation_name with a value equal to annotation_value. (The inverse is true for !=.)

If a phrase element begins with [hh] it searches through host history information. [hh] is a way of identifying that the phrase is to be checked using the host history. This phase element expects a format like [hh]k1:v1=k2:v2. The host history is stored as an array of hashes. Thus, the host history phrase elements ask the question ‘Does a hash with key k1 and value v1 exist, and if so, does that same hash's k2 equal the value v2?’

If a phrase element begins with [past-pcode] it checks to see if a past procedure code (pcode) was identified in the past (either within a time period, or in general.) [past-pcode] is a way of identifying that the phrase is to be checked using the past decisions from IP Tools system 110. This phase element expects a format like [past-pcode](known_date<number_of_days)=pcode identified or [past-pcode]=pcode identified. If no number of days or known date is included (the latter example) it will evaluate true if that past_pcode was ever identified for the matter. If the [past-pcode](known_date<number_of_days)=pcode identifier is chosen, this evaluates as ‘true’ if the pcode identifier was identified within a number_of_days from a date relating to the current document (such as maildate).

If a phrase element begins with REGEX, the rest of the phrase element is evaluated as a regular expression and the OCR output is searched for that regular expression. As known to those skilled in the art, REGEX is a system of expressing pattern matching on computers. If there is a match, the phrase element evaluates to ‘true.’

If none of the above is true, the spaces are removed from the OCR, and the AAS 120 checks to see if the phrase element is contained within the OCR with the spaces removed. If the phrase element ends in ‘lwithinXchars’, the AAS 120 looks at the first X characters of the OCR for the phrase. If the phrase contains parentheses, then those parentheses are optional.

In sample embodiments, the AAS 120 receives annotation files with documents with extracted PTO IDs and corresponding pcodes provided by data extraction system 115. The AAS 120 may store the generated data in AAS Data Tables containing phrase rules for the respective documents. For example, as illustrated in the following table, the documents annotated by the AAS 120 may be represented in AAS Data Tables as follows:

AAS Data Table

| | | | Phrase Rules to Identify |
|---|---|---|---|
| Unique ID | Name | Country Code | Document |
| [PTO_ID] | [Final Rejection] | USA | [Pointer to file history or |
| | | | other data sources that |
| | | | phrase rules apply to for |
| | | | resolving different tags] |

As an example of the phrase rules, if the document is an open Office Action, the document may tag as a pcode a response to Office Action and point to the data sources that the phrase rules apply to. The file history requirements may be in the phrase rules or in a Multidoc table. The phrase rules tag or identify documents and establish whether reminders are desired. For example, an Official Action may include multiple reminders for the response due date and any extensions.

A Multidocs rules table may include multiple tags such as a combination of tags for a first document and a listing of rules including a combination of PTO-IDs that correspond to a particular document type (one PTO_ID). For example, if several documents are tagged as an Official Action, a PTO-1449, and an Information Disclosure Statement, this combination of tags may be represented by a single PTO_ID for an Official Action. The corresponding procedure code (pcode) in the IP Tools system 110 file history may include for a pcode the date received, date filed, date mailed for an office action type from a particular country and the common procedure that is to be performed for the customers for that pcode. Other fields in IP Tools system 110 may include a host bibliographic file that includes bibliographic files and normalized dates, PAIR files from www.uspto.gov, and the host history records of docketing transaction to a particular customer (e.g., activities to customer's docketing system 140).

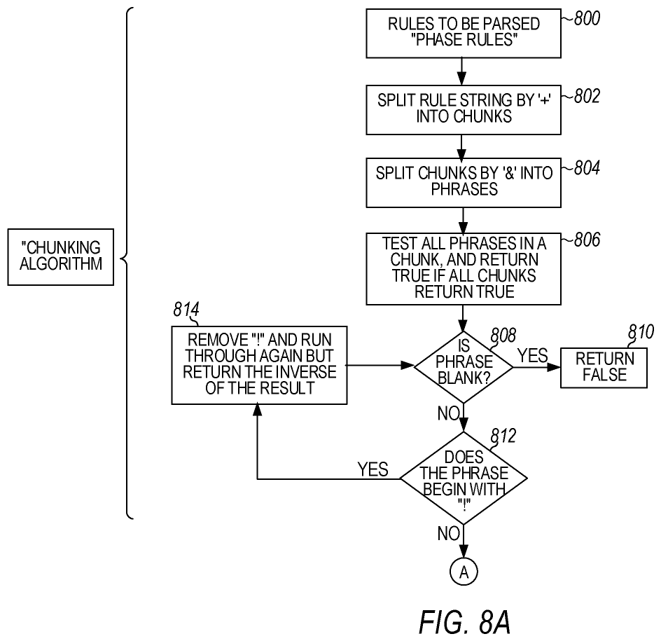

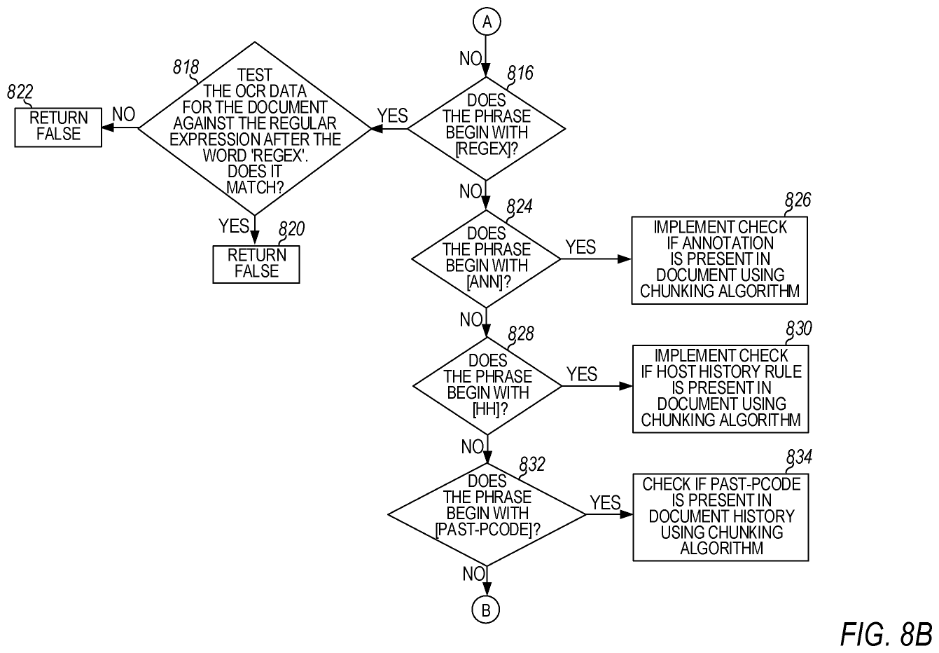

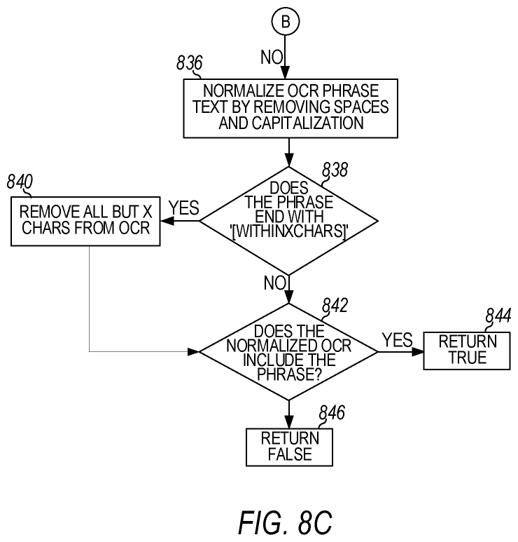

FIGS. 8A-8C together comprise a flow chart illustrating the phrase rule logic of the AAS 120 in a sample embodiment. As illustrated, the phrase rule to be parsed is input into a chunking algorithm at operation 800. The rule string is split into chunks at operation 802 by inserting ‘+’ between strings in the rule. The chunks are then split into phrases at operation 804 by inserting ‘&’ between phrases. The phrases in a chunk are tested at operation 806 and a ‘true’ is returned if the chunks return a ‘true’ during testing. If it is determined at operation 808 that a phrase is blank, a ‘false’ is returned at operation 810. Otherwise, the phrase is evaluated at operation 812 to determine if it begins with a !′. If so, the !′ is removed at operation 814. Operation 808 is repeated but the inverse of the result is returned.

Upon completion of the chunking algorithm, the phrase is checked at operation 816 to determine if the phrase begins with “REGEX.” If so, the OCR data for the document is tested against the regular expression after the word “REGEX” at operation 818 to determine if there is a match. If so, a ‘true’ is returned at operation 820; otherwise, a ‘false’ is returned at operation 822.

The phrase is further checked at operation 824 to determine if the phrase begins with the phrase element [ann]. If so, the document is checked at operation 826 to determine if an annotation is present using the chunking algorithm (operations 800-812).

Similarly, the phrase is further checked at operation 828 to determine if the phrase begins with the phrase element [hh]. If so, the document is checked at operation 830 to determine if the host history rule is present in the document using the chunking algorithm (operations 800-812).

The phrase is also checked at operation 832 to determine if the phrase begins with the phrase element [past-pcode]. If so, the document is checked at operation 834 to determine if a past-pcode is present in the document history using the chunking algorithm (operations 800-812).

If none of the above is true, the OCR phrase text is normalized at operation 836 by moving the spaces and capitalization from the OCR. The AAS 120 then checks to determine whether the text phrase ends with ‘lwithinXchars’ at operation 838. If so, all but the X characters are removed from the OCR at operation 840. Otherwise, the normalized OCR is checked at operation 842 to determine whether the normalized OCR includes the text phrase. If so, a ‘true’ is returned at operation 844; otherwise, a ‘false’ is returned at operation 846.

To determine what happens when a rule is identified, reference is made back to FIG. 7.

Once a rule is identified as being accurate, the rule's UDOCIID is added to the document's UDOCIID list. Any ‘required annotations’ are also added to the list of annotations for the document, which is how non-rule-based annotations may be added by the AAS 120 at operation 730 of FIG. 7.

Once the AAS 120 has gone through the ‘Unified Rules’ Excel file, the AAS 120 does a second pass to identify a single ‘PTOID’ for each document to thereby identify the documents in the context of the file. To do so, the AAS 120 performs operation 735 to look through the ‘Multidoc Rules’ Excel file and to remove any rules that are not relevant to the current document (e.g., rules that are not from the same country). The Multidoc rules use anything from the multiple documents in the zip file that may be useful to identify the ID of a document and to assign an identification code. For example, something in the zip file may identify the document from a previous pass through the automated docketing system. Then, the AAS 120 performs processes including:

### PTO ID Annotations

The AAS 120 looks at the ‘PTO ID Annotations’ column for each rule and looks for a rule where the UDOCIIDs identified in the previous step match the list of PTO ID Annotations in the rule. If a rule matches, then the rule's PTOID is set, barring a Mult-Allwd exception described below.

### PTO ID Contains Annotations

The ‘PTO ID Contains Annotations’ column is reviewed for each rule. The AAS 120 looks for a rule where the UDOCIIDs identified in the previous step contain the UDOCIIDs in the list of ‘PTO ID Contains Annotations’ in the rule. If a rule matches, then the rule's PTOID is set, barring a Mult-Allwd exception described below.

### Mult-Allwd

This is a feature that stops multiple documents of the same type from being identified at the same time. This is a way for people writing rules to stop more docketing to happen than is necessary. In the most obvious case, this will stop two copies of identical documents from going through. If Mult-Allwd is set to ‘no,’ then the AAS 120 checks through other documents within the zip container and does not identify the document with the PTOID if a previous document in the zip container has already been identified. If one has already been identified, its PTOID is changed to have ‘SUPPRESS:’ prepended to the PTOID, stopping any other action from occurring while still letting future systems know how the document was identified.

In sample embodiments, an item to be docketed can be identified in at least two different ways. First, a document may be identified by giving it a PTO-ID. A procedure for processing the document then may be identified automatically using the PTO-ID. Second, a procedure for the document may be chosen without assigning a PTO-ID to the document. However, in some cases, there may be several different procedures that can be used for the same document, so there is not a one-to-one mapping of a PTO-ID to a procedure used to docket the item.

In the sample embodiments, at least two strategies may be used to prevent duplicate documents from being docketed more than once. For any given multi-document rule that automatically assigns a PTO-ID, there are two different options for making sure that it is not used to automatically docket a duplicate. For example, a rule may specify that this same document/PTO-ID is not to be assigned more than once within a given period, say 60 days from when the first occurrence of the document/PTO-ID. So, if a “first office action” document is received for a given matter, the system will not allow another “first office action” document to be automatically identified within 60 days. Alternatively, a rule may specify that if a particular one or more procedures has been used recently, the assignment of the document/PTO-ID specified by the rule is blocked for a given period, say 60 days from when the procedure(s) was used. So, if a “first office action” procedure is used for a given matter, the system will not allow another “first office action” document to be automatically identified within 60 days. As another alternative, both the PTO/ID and the procedure has been used recently (as recognized by presence of same pcode), both may be blocked based on document (PTO-ID) and the procedure(s).

### Recognition Modes

Recognition modes are an additional edge case on Multidoc PTOID Annotations. In some cases, a matching annotation is performed using the PTO ID Annotations, but it is desirable to be able to ignore certain classes of UDOCIID identified. In sample embodiments, there are three recognition modes:

ALL—This will consider all of a document's UDOCIIDs when comparing them to the ‘PTO ID Annotations’ column.

Ignore agt rules—This will consider all of a document's UDOCIIDs except those that have ‘agt’ in them when comparing them to the ‘PTO ID Annotations’ column.

Ignore nonagt rules—This will consider all of a document's UDOCIIDs except those that don't have ‘agt’ in them when comparing them to the ‘PTO ID Annotations’ column.

This is just a filtering that occurs before the Multidoc identification step on a per-rule basis.

### 3. Annotating Documents

By the time the AAS 120 has attempted to identify a PTOID for each document, a number of annotations (key-value pair) on each document have already been generated through the ‘Requires Annotations’ rules. Several annotations may be run in code at this point. Some are simple. For example, a customer name annotation is collected by searching the OCR for ‘BHIPCustomerName:’. Some are more complicated. For example, the OCR text may be sent to an API to generate a predicted PTO ID from a Machine Learning algorithm. Other annotations may do things like calculating dates out of an image file wrapper xml from the USPTO, then determining if this mailing was received within a designated number of days of a particular event. The annotations may be customized to a particular customer and may or may not be intuitive. The annotations may also be implemented as user configurable files including template definitions that identifies particular expressions to identify a particular document.

In sample embodiments, annotations are generated through short functions that can be added quickly. These functions tend to be in a similar format. They start by limiting the scope of the function—immediately failing if the document is not from a relevant country, or does not have sufficient information to calculate. If the annotation function succeeds, it will add a new annotation to the document as a whole. This method of generating annotations is used when the rule-based system is not sufficient to generate a complex piece of information about a matter. It will be appreciated that the system need not be rule-based as the annotations are not generated based on Unified or Multidoc rules, where the Multidoc rules identify a single PTOID where a plurality of rules may apply to a particular document. Instead, they are generated using a series of functions that attempt to place complex annotations on every document that goes through the system.

### 4. Conditional Functions

With reference back to FIG. 7, some Unified rules set conditional functions. The AAS may run the conditional functions (e.g., sending emails and saving files) at operation 740. The conditional functions are an additional level of processing that can occur after the other processing has been done for a document, but before saving the output. These conditional functions take a ‘conditional phrase rule’ as a parameter which is a secondary ‘phrase rule’ and evaluates the same way as a ‘Unified Rule's phrase rule. This allows a unified rule to be matched, and for it to have a conditional function that gets run some of the time. For example, the conditional function may be run for a particular customer and may be run multiple times during multiple passes that classify the document in the customer's specific format. The conditional functions may include:

Copy-Forward allows someone writing a rule to have either the zip file or the PDF of the document forwarded in an email to an email address with a subject line and body.

Copy-Save allows someone writing a rule to save either the zip file or the PDF of the document to a particular shared folder.

The Copy-Forward and Copy-Save conditional functions enable a user of the automated docketing system to docket documents received for a client of the customer in the customer's docketing system 140 (FIG. 1). In this scenario, the received document is processed by the automated docketing system 100 and docketed into the customer's docketing system 140. A copy is also docketed in a client's system of the customer's docketing system 140. In sample embodiments, these functions are accomplished using IP Tools system 110 by receiving the original document by IP Tools system 110, which validates the received document (i.e., IP Tools system 110 determines to which file in the customer's docketing system 140 to docket the received document). The received document is sent to the AAS 120 with at least the following attributes: Client number or Client name from the customer's docketing system 140; text of document; and other annotations of document (e.g., serial number). Before the document is sent to the AAS 120, a Copy-Forward rule is configured by a user that specifies, for example, that the rule applies to any document for a given client of the customer's docketing system 140, an email address to forward the document to, a subject for the email, and a body for the email. When the AAS 120 receives the document for the given client, the AAS 120 automatically copies and forwards the document to the designated email address. Alternatively, the AAS 120 may save the document to a designated directory/folder, as opposed to emailing it, or it can both email and save a copy.

Because groups of documents are often received attached to a single e-mail, as happens when foreign docketing is received from foreign agents, the Copy-Save and Copy-Forward rules allow a user to configure if they want just one copy of the group to be sent or saved together, or if they want documents to be sent individually. In such cases, the user may identify documents based on as many attributes as they want, e.g., the user may Copy-Save certain types of documents for a specific client, or Copy-Forward a particular type of document irrespective of what client it is for.

The Copy Save/Copy Forward functionality may also be used to handle ancillary documents. For example, the received documents and related ancillary documents may be handled in the same fashion.

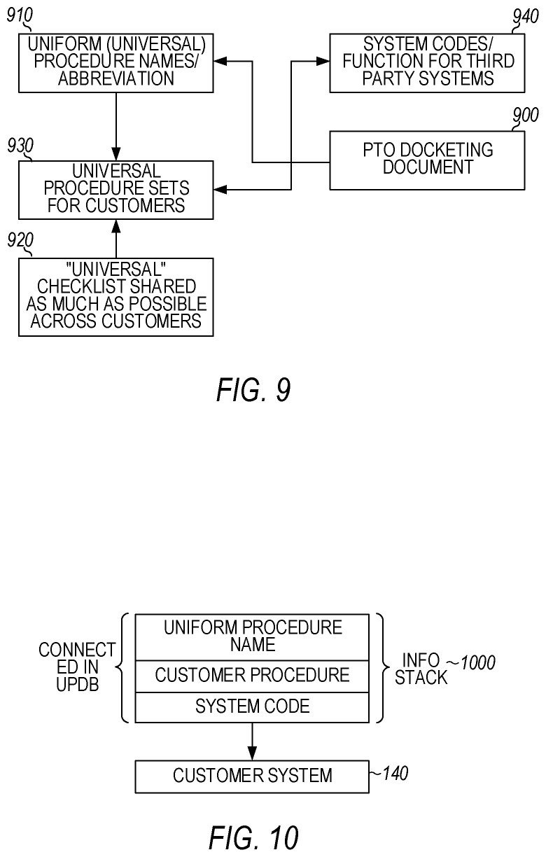

To implement the Copy Save/Copy Forward functionality, the AAS Data Table is checked to determine if the criteria for the phrase rules are satisfied. If the criteria for the phrase rules are satisfied, the AAS 120 may do one of three things:
1. copy the document and save it in a folder (Copy-Save);
2. save the zip file; and
3. copy the document and forward it to an email address (Copy-Forward) if forwarding criteria are met (e.g., forward to client if client code is included and resubmit to client system with unique client rules as appropriate for processing according to the unique procedures of the client).
   In the case of Copy-Forward, the customer's email address may be pulled from IP Tools system 110 and validated in the customer's docketing system 140 before the special procedures for that customer are applied based on the customer number for that customer that identifies the set of procedure codes to use (see FIG. 9 below).

### 5. Saving Output

Referring back to FIG. 7, once the files have been categorized and annotated, the categorized and annotated files are saved to the shared folder at operation 745. The categorized and annotated files also may be saved to a Report folder, from which the files may be exported. Saving the files may involve generating an Excel file with one row for each document in the input zip file and one row for each attribute known about each document, including almost all annotations and the PTO ID as determined by the Multidoc rules. Some annotations are not included for space-saving reasons if IP Tools system 110 already knows about them. For example, host bibliographic data is not saved to the Excel reports since the bibliographic data may not be changed while in the AAS 120. The bibliographic data is just static data about what is in the customer's docketing system. IP Tools system 110 then picks up this completed report from a file sharing location and processes the export from the AAS 120.

The AAS 120 may also save pertinent data about each document to a database at operation 750. Each identified document is stored separately. This is used for reference, for analyzing issues or trends, and for training machine learning algorithms using the identified data at operation 755. The AAS 120 may also fetch data from external data sources for use in external annotations at operation 760. Such external data sources may include the USPTO, custom OCR extractors, and machine learning algorithms trained on the AAS result database updated at operation 750.

Finally, any conditional functions are added to a document's list of conditional functions to be run. AAS 120 also sends emails for some document types. Sending emails provides a way to generate new docketing requests dynamically. For example, in one case, documents identified as a particular category may be sent through a specialized OCR function built specifically to extract annotations for table-based PDFs. The custom OCRed documents may be sent back into the system at operation 765 so they can be processed separately. This ability to ‘loopback’ a document through AAS 120 and to re-route the document can be quite powerful and enable more efficient docketing.

### Machine Learning

Machine learning techniques may also be used to generate annotations. For example, the database of past documents that have been identified may be used as a data warehouse to train and improve machine learning models by creating a training set for the machine learning model. Over time, the machine learning model system 150 (FIG. 1) will learn which PTO IDs to use for which documents. Each document that comes through AAS 120 may be sent into an application programming interface (API) of a machine learning model system 150 that analyzes the document based on the machine learning model. The API would then return the machine learning model's predicted PTO ID along with the PTO ID generated without use of the machine learning model. In a sample embodiment, the machine learning model system 150 would be used to test the classifications. In such a configuration, if the prediction is consistent with the generated PTO ID, then the PTO ID would be accepted; otherwise, the PTO ID would be thrown out as indeterminate. In such sample embodiments, the training data for machine learning may be assigned a PTO-ID for the machine learning model system 150 that is different than the PTO-ID for use in docketing, using the Multidoc rules described above.

In sample embodiments, the separate PTO-ID for the machine learning model system 150 may be used to redirect documents to the machine learning model system 150 for training purposes. The machine learning model system 150 may also apply a Multidocs rules table if more than one PTO-ID is provided in order to refine the PTO-IDs down to a fewer PTO-IDs for processing. For example, rules in the Multidocs rules table may indicate that a collection of tags corresponds to a single training tag, in which case the documents would be forwarded to the machine learning model system 150 for training purposes. On the other hand, if there is no rules match by the machine learning model system 150, the document may be identified for manual evaluation by a human docketer.

In sample embodiments, the machine learning model system 150 may train on a receipt rather than a particular response in order to identify the associated Multidoc rules. The machine learning model system 150 may then learn each document that corresponds to the receipt and use a rules table to assign a final example to the identified documents. Thus, when a PTO ID is recognized, it may be assigned not only to a particular Office Action but also to the response due and linked to the corresponding pcode for the Office Action response.

Machine learning model system 150 may also be used for predictive docketing. For example, in a case where a document cannot be identified based on a phrase rule, the machine learning model system 150 may recognize that particular text shows up in a document that corresponds to a particular procedure code and docket the document according to the procedure code. The AAS 120 may verify the document on the front or the back end. On the other hand, the back end verification may be performed by humans.

As an example, if a Non-Final Office Action is received with an agent letter without a restriction requirement, the system may scrape information from the documents to enable the document to be automatically entered into the customer's docketing system 140. The associated rules from the UPDB 130 describe how to enter the annotations into the template for that document type. The system would then tell the operators what Office Action to expect next (e.g., a Final Office Action).

### Rule Evaluation

As noted above, UPDB 130 provides universal procedure codes (UPCs) that are used in conjunction with customer specific codes, checklists, and templates to specify how to fill in the templates and how to complete customer-specific procedures such as how to docket documents into the customer's docketing system 140. It is possible for the UPDB 130 to occasionally generate bad rule files. Sometimes this is caused by human error or bad exports. For this reason, the AAS 120 has built in resiliency features that ensure that every hour backups of the rules are generated. If AAS 120 notices there are far fewer rules than in the past, the AAS 120 may revert back to the old rules and alert the system administrator of any issues. Thus, by the time the IP Tools system 110 attempts to identify a PTOID for each document, a number of annotations on each document will have already been generated through the ‘Requires Annotations’ rules. As noted above, an annotation is effectively a key-value pair.

A number (e.g. 30) of annotations may get run in code at this point. Some annotations are simple. For example, a customer name annotation is collected by searching the OCR for ‘BHIPCustomerName:’. Some annotations are more complicated. For example, an annotation may be used to send the OCR text to an API to generate a predicted PTOID from a Machine Learning algorithm. As noted above, other annotations do things like calculating dates out of an image file wrapper XML, from the USPTO and then determining if this mailing was received within a predetermined number of days of a particular event.

The data structure described herein provides connections of PTO documents (records) to the UPDB 130 that is the same for customers, no matter what IP system they use. Since the procedures for customers are named the same if equivalent (enforced by requiring a procedure to be named using one of the Uniform Procedure Names), the users can easily navigate from one customer's docketing system 140 to another, as the system codes are in essence hidden from them by making docketing choices based on the PTO document they have in front of them, which in turn points to a Procedure, through the Uniform Procedure Name record. The actual procedure for a customer may have its own checklist (docketer guidance), or (full or partial) automation, and may be custom configured to the customer's process and IP system. With the AAS 120, many documents can be automatically recognized, which then in turn automatically leads the user to the appropriate procedure for the customer for whom they are docketing. If fully configured for automation, the AAS 120 allows documents to flow through without any human looking at the documents being docketed.

FIG. 9 illustrates the formation of the uniform universal rules sets and system specific rule sets to enable the customer procedure sets to use the same naming convention for equivalent procedures in sample embodiments. As illustrated in FIG. 9, a USPTO docketing document 900 may include a record for each type of document event to be docketed. The record is provided in table form to provide uniform (universal) procedure names and abbreviations records 910 that are linked to corresponding USPTO documents. A “universal” procedures checklist 920 that is shared as much as possible across customers may also be provided. A table containing the uniform (universal) procedure names and abbreviations and a table containing the “universal” procedures checklist may be combined into a universal procedures set for customers 930. The corresponding system codes and functions 940 may be provided in a table to third party systems such as the customer's docketing system 140 for performing the corresponding docketing functions.

The uniform procedure names, customer procedure, and system code are combined into an information stack 1000 and stored in UPDB 130 as shown in FIG. 10. The customer's docketing system 140 is updated at regular intervals to include the information stack 1000 by the push operation of the IP Tools system 110. Thus, the information in the information stack 1000 is connected in the UPDB 130.

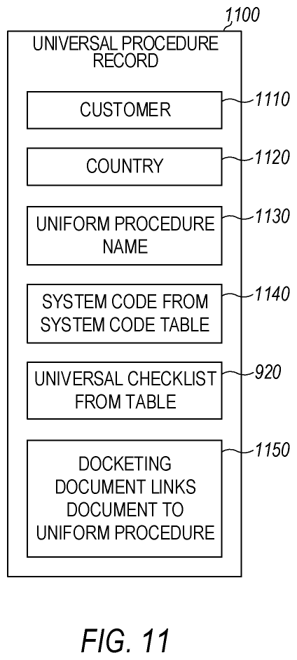

As illustrated in FIG. 11, the resulting universal procedure record 1100 may include standard information such as customer 1110 to which the rules apply, the country 1120 for which the rules apply, and a uniform procedure name 1130 taken from the information stack 1000. The universal procedure record 1100 may further include system code from a system code table 1140 as well as a universal checklist 920 from a table stored in UPDB 130. In sample embodiments, a docketing document 1150 links the received document to the uniform procedure so as to enable processing of the corresponding uniform procedure.

The reporting tool 135 may collaborate with IP Tools system 110 to automatically create letters for auto-reporting. For example, a report out template may be stored in UPDB 130, and any updates to the templates in the UPDB 130 are pulled into IP Tools system 110. The report out template may include tags that pull data (e.g., due date) from the customer's docketing system 140.

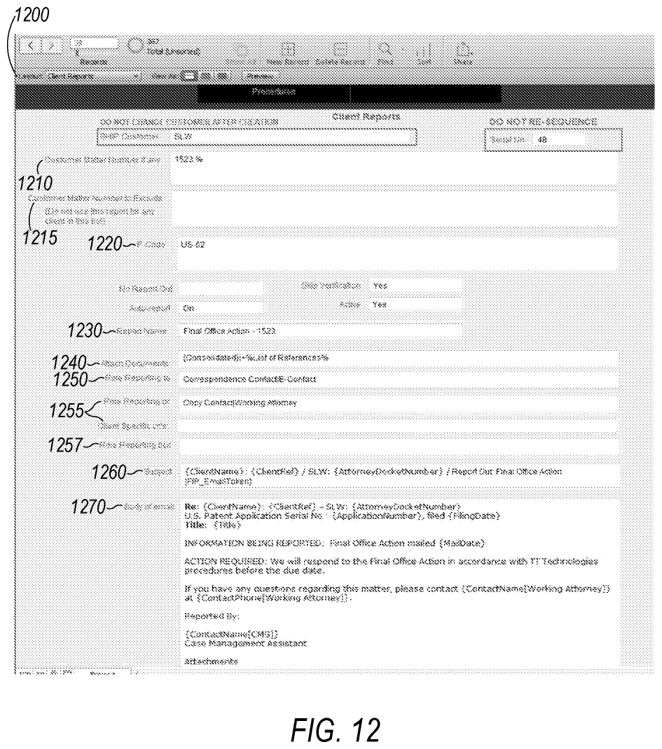

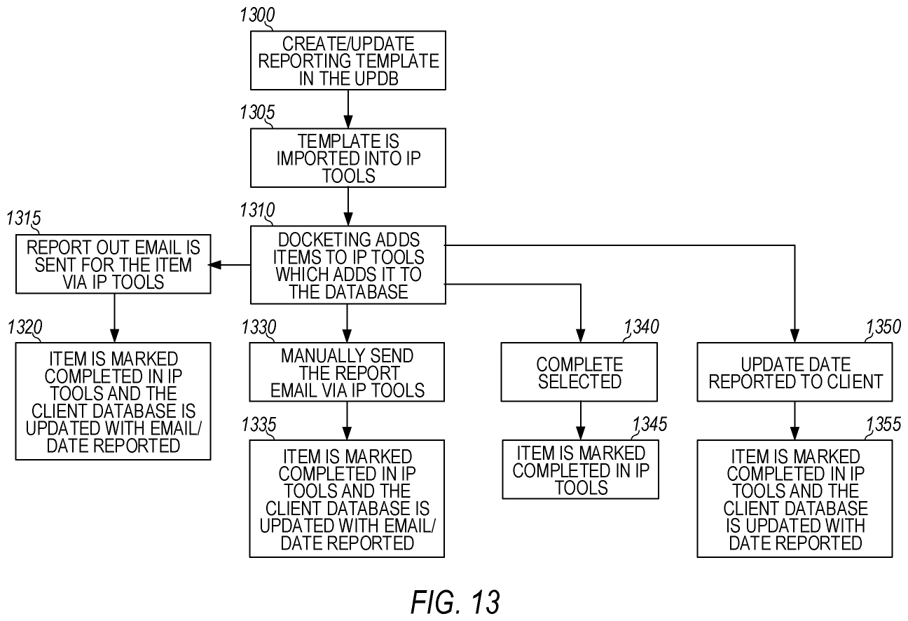

FIG. 12 illustrates a sample screen shot of a report out template 1200 illustrating the customer number 1210, P-Code field 1220, Report Name field 1230, Attach Documents field 1240, addresses of recipients of the report in Role Reporting field 1250, as well as Subject field 1260 and Body field 1270 of the reporting email. In sample embodiments, the customer name and the serial number of the application should auto-populate. The customer number 1210, if any, is added if the letter is specific for certain clients. The format is client #.%, and if there are multiple client numbers, a bar | is used to separate the multiple client numbers, where the % is the wildcard in the system. For example: 4218.%|1523.%|2043.%. If nothing is listed in this field, then the letter is for all clients unless matters are listed in the next field—Customer Matter Number to Exclude 1215. The Customer Matter Number to Exclude field 1215 identifies clients and matters that are not to receive a reporting letter.

As illustrated in FIG. 12, the P-Code field 1220 is the docketing procedure code to which the reporting template is tied. The P-Code field 1220 is like an activity code in a docketing system; it is the code the docketing system uses to add the item to the IP Tools system 110. Multiple docketing procedures may be listed if separated with a bar |. For example: US-160.6|US-160.3.

The Report Name field 1230 is the name given to the report, which differentiates the template report from the other templates. The Attach Documents field 1240 provides the user the option to list what to attach to the report out. If left blank, a standard format is used and the document as docketed will be attached. In sample embodiments, the report out lists the file number, country code, and document name. For example:

### 5086 013US1-US-Original_Recorded_Assignment.pdf

is the original recorded assignment in PDF for client/matter 5086/013US1 in the U.S. Other documents may be added or renamed to fit client requests. For example:
Office action and NORC and/or 1449={Consolidated}|+% List of References %
Issue notification client specific={Consolidated[{ClientRef} IN {MailDate[dd MMM yyyy]}]}
Item filed, include Word document={Consolidated(DOC)}|{DOC}

The Role Reporting field 1250 identifies who will be listed in the To line of the report out email. Similarly, the Role Reporting cc field 1255 identifies who will be listed in the cc line of the report out email and the Role Reporting bcc field 1257 identifies who will be listed in the bcc line of the report out email.

The Subject field 1260 lists what the subject line of the email is expected to be. The subject line can be customized at the client's request. The corresponding tags may be used to pull data from IP Tools system 110 and/or the customer's docketing system 140.

Finally, the Body field 1270 of the email lists what will be in the body of the email. The body of the email may be customized at the client's request. The corresponding tags may be used to pull data from IP Tools system 110 and/or the customer's docketing system 140.

It will be appreciated that the values for these fields may be stored in the UPDB 130 or in a separate database and the data pulled into the template 1200 automatically or selected from a drop down list to generate the email report.

FIG. 13 illustrates a flow diagram of the reporting process in a sample embodiment. As illustrated, the process starts at operation 1300 by creating and/or updating a reporting template such as reporting template 1200 in UPDB 130. The reporting template is imported into the IP Tools system 110 at operation 1305. At operation 1310, items to be docketed are added to the queue of the IP Tools system 110 and forwarded to the customer's docketing system 140 once the docketing processes are identified as described herein. Once the automated docketing process has been completed, a report out email is automatically generated at operation 1315 and sent for the docketed item via the IP Tools system 110. The docket item is marked as completed in the IP Tools system 110 and the queue in IP Tools system 110 is updated. Also, the customer's docketing system 140 is updated with the email and date reported at operation 1320.

On the other hand, when the docketing process cannot be performed automatically (as when the automated docketing system 100 and the customer's docketing system 140 are not integrated or semi-integrated), the report out email is created and stored in the IP Tools system 110 at operation 1325 for manual processing. In such a case, the report email is manually sent at operation 1330 via the IP Tools system 110. The docket item is marked as completed in the IP Tools system 110 and the queue in IP Tools system 110 is updated. Also, the customer's docketing system 140 is updated with the email and date reported at operation 1335. The human docketer may also select that the reporting process is complete at operation 1340 for the case, for example, where no report is to be generated. The docket item is then marked as completed in the IP Tools system 110 and the queue in IP Tools system 110 is updated. Additionally, if the report is provided by other means, an update of the report out date may be reported at operation 1350. Once again, the docket item is marked as completed in the IP Tools system 110 and the queue in IP Tools system 110 is updated. Also, the customer's docketing system 140 is updated with the date reported at operation 1355.

The automated docketing system described herein thus enables completely automated processing of received documents and docketing of the documents into the customer's docketing system 140 when the customer's docketing system 140 and the automated docketing system 100 described herein are integrated or semi-integrated. On the other hand, when the customer's docketing system 140 and the automated docketing system 100 described herein are not fully integrated, the automated docketing system 100 described herein may identify what it cannot find and provide a queue to a human docketer to manually identify what the system could not identify. These identifications may then be fed back into the automated docketing system 100 to increase its knowledge base for future document identifications (e.g., by updating the machine learning corpus). Also, the automated docketing system may be useful even when the customer's docketing system 140 is separate. In such a case, the human docketer may use the universal procedures checklist from the UPDB 130 and a print out of the automated docketing system 100 to docket received documents manually. The resulting printouts may also be used to drive prosecution analytics systems. For example, a docketing status tab may identify what documents have been received in a given time period, how many or what types of documents were received, and provide different types of reports based on user inquiries.

Also, in further sample embodiments of the automated docketing system 100 described herein, messages may be sent to the human docketer based on one or more identification factors. In such embodiments, a message, based on how the document is identified, is created to send to the human docketer and can be used for any purpose such as a warning, a suggestion of how the document is to be identified, a note that the document has been identified, instructions on how to docket the document, help messages, etc. The rules identifying a document may include a unique message that may be generated, prioritized, and sent to the human docketer based on identification factors identified during the automated document identification process. For example, the message to a human docketer may indicate whether the document identification is certain or doubtful. Each rule may have a different predefined message associated with it that is presented to a human docketer when the annotation rule is invoked. Also, another field may be provided in the Multidoc rules to include a unique message for a Multidoc rule set.

### Multi-Stage Human Assisted Machine Docketing

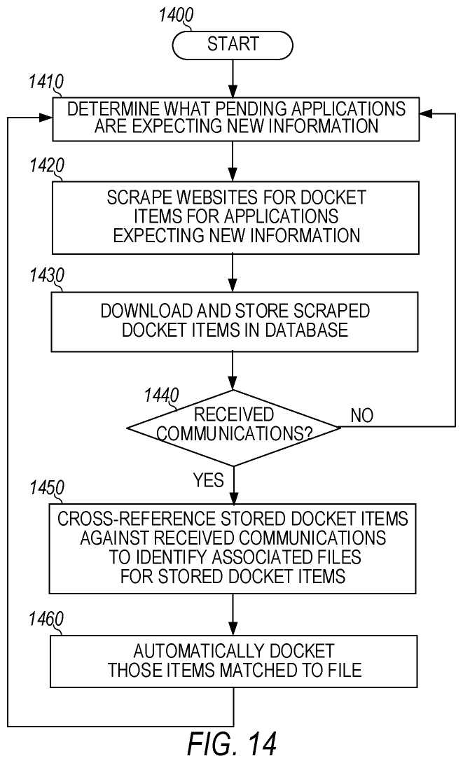

In another sample embodiment, the automated docketing system may be adapted to pre-save information before the information is docketed. For example, in the intellectual property docketing embodiment illustrated in FIG. 14, the automated docketing system may start at 1400 and determine what pending applications are expecting new information at 1410. At 1420, the patent office websites are scraped using a scraper tool such as the scraper tool 420 described above with respect to FIG. 4 for docket items posted against those pending patent applications determined to be expecting new information. In sample embodiments, the scrape is predictive. For example, by going through a list of current applications and the status of each of them, the algorithm may determine if it is likely that a new document/action will be present on a respective country's patent site at 1410. The algorithm will then look specifically for this application number on this country's specific web page and scrape the website at 1420 if the application number is present. The algorithm may repeat this process for each and every application. In a sample embodiment, the algorithm may implement a programmed window with logic such as “If the last document was of type X, a response to X can be expected in a known time interval. Then, when the scrape is run, this application would only be searched for during this time interval.” The scraped data may include free text data, PDF data, WORD data, XML from PAIR including transaction history, etc., metadata, and the like.

In sample embodiments, the scraper tool may change its IP address and user agent periodically to effectively appear as a separate computer. The scraper tool thus has a number of “identities” that it shuffles through like a deck of cards. Each scrape is performed using one identity, then the scraper tool uses the next identity in the list until a predetermined number or all identities are used and then the list is reshuffled. By changing identity in this fashion, it is much less likely that the scrape requests will be blocked by the respective patent office websites.

The scraped docket items are downloaded and stored in a database at 1430 for further processing. Then, when a communication is received at 1440, any new item with an expected application number may be pulled from the database and cross-referenced against received communications (e.g., documents associated with incoming agent communications) at 1450 to identify the corresponding pre-stored item. Each pre-saved docket item matched to a file may be joined to the incoming communication, as appropriate, and automatically docketed at 1460 as described above. It will be appreciated that the scrape data is generally a complete history of a given application (or at least as up-to-date as the website). Once a new file comes through associated with a given application, the current state of the application is updated with the latest information. Thus, when the last document type goes from type X to type Y, the algorithm calculates when the next item is expected based on new item Y, and the process repeats at 1410. This process may be used, for example, to perform automated reporting, automated preparation of Information Disclosure Statements, etc. with respect to the associated portfolio.

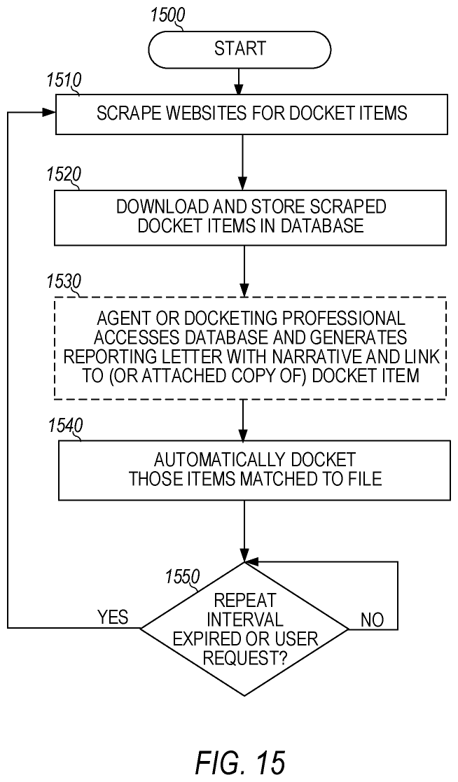

In a further sample embodiment, the automated docketing system may be adapted to pre-save docket items in a database associated with a portfolio. The pre-saved items may be pulled from the database for use by respective agents, docketing professionals, etc. For example, in the intellectual property docketing embodiment illustrated in FIG. 15, the automated docketing system may start at 1500 and scrape the websites of patent offices around the world at 1510 for docket items posted against pending patent applications. The scraped data may include free text data, PDF data, WORD data, XML, from PAIR including transaction history, etc., metadata, and the like. The scraped docket items then may be downloaded and stored in a database at 1520 for further processing. The database may be generic or associated with a particular patent portfolio. At 1530, an agent or docketing professional may optionally access the database and generate a reporting letter with a narrative and a link to (or a copy of) the pre-saved items. A link may be used when the reporting letter is being sent to others agents or docketing professionals with access to the database. In this embodiment, the agent may log into the database and attach a narrative to the pre-saved documents without having to track the downloaded items. For example, an agent may create a manifest record for attachment to a reporting email as described in U.S. patent application Ser. No. 17/097,233 referenced above. In any case, the docket items are matched to a file at 1530 and automatically pulled from the database to enable automatic docketing at 1540 as described above. This process may repeat at regular intervals (e.g., daily) at 1550 or as requested by a user. This process may be used, for example, to perform automated reporting, automated preparation of Information Disclosure Statements, etc. with respect to the associated portfolio.

In alternative embodiment, a database is not needed. In this embodiment, an agent may enter the country and application number into a website operated by the operator of the docketing system. The website may then perform a live scrape of the patent office website(s) to gather the requested data using the provided information. The results from the scrape are then used to populate further steps for the agent on the docketing system website. For example, the agent or docketing professional may generate a reporting letter with a link to, or copy of, the real-time scraped data or pre-stored scraped data. This approach is possible because a directed scrape looking for a specific application number only takes one or two seconds.

### File Wrapper Breakout

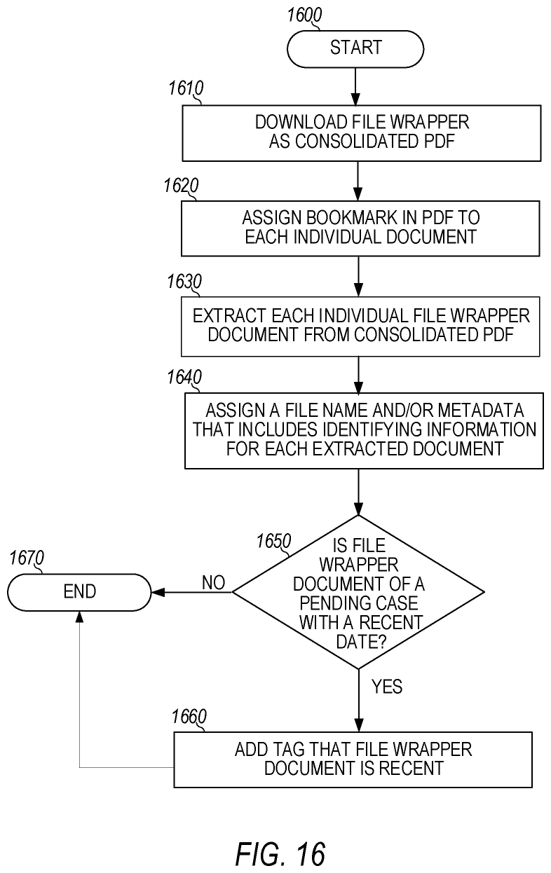

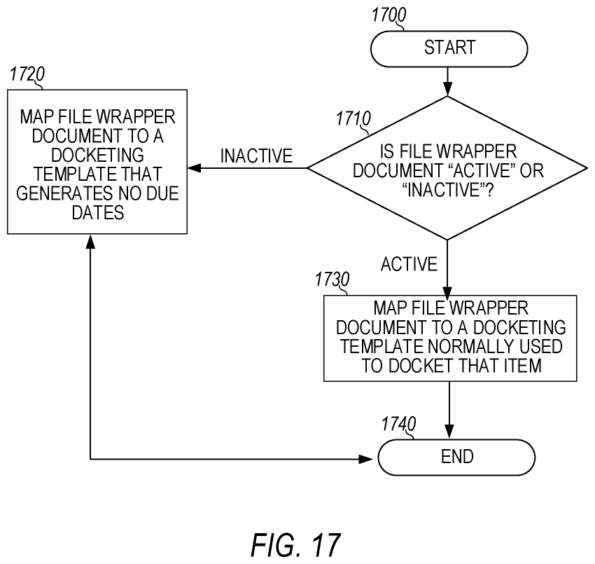

In another sample embodiment, the automated docketing system may be adapted to automatically download and breakout the contents of a file wrapper for insertion into an existing IP docketing system (e.g., Foundation IP, CPI, Anaqua, etc.) of existing document management system. In the sample embodiments, the documents of the automatically downloaded file wrapper may be annotated and processed as described above with respect to FIGS. 1-15. FIGS. 16 and 17 illustrate the process for breaking out a downloaded file wrapper in sample embodiments.

In the sample embodiment illustrated in FIG. 16, the automated docketing system starts at 1600 and uses the afore-mentioned scraping process to download a file wrapper as a consolidated PDF from the country's patent site (e.g., uspto.gov) at 1610. Each separate individual file wrapper document (FWD) is assigned its own bookmark in PDF at 1620. Each individual FWD is then extracted from the consolidated PDF at 1630 and each FWD is assigned a file name and/or metadata at 1640 that includes, for example:

A. the date of the document (e,g, the USPTO's PAIR system includes a date for each document, typically a mail date or date received);

B. the serial number; and

C. the PTO name for the document together with a tag such as “file-wrapper-breakout” (e.g. “Final Rejection—file-wrapper-breakout.” It should be noted that bookmark names sometimes contain illegal characters so the name has to be made into an acceptable name for use as a file name in the operating system (e.g., WINDOWS®, MacOS®, or Unix®).

At 1650, it is determined if the FWD is for a pending case and has a date that is recent (e.g., within last 8 months). If so, it is assumed that the case is active, and a tag (e.g., “active”) is added to the FWD at 1660 indicating that the FWD is recent and active. The process ends at 1670.

In this fashion, the process of FIG. 16 generates a group of FWDs that represent the file wrapper for an application and/or patent. In the case of an application, the documents are tagged as “active,” while a file wrapper document for an issued patent is either not tagged or tagged as “inactive.” The resulting FWDs may then be processed by the automated docketing system for insertion into the existing IP docketing system as described above.

FIG. 17 illustrates further processing of “active” and “inactive” FWDs in the sample embodiment. As illustrated, the process starts at 1700 by receiving the tagged FWDs from FIG. 16 and determining at 1710 if the received FWD is “active” or “inactive.” If the received FWD is “inactive,” then it is mapped at 1720 to a docketing template of the existing IP docketing system that loads an activity with the date and the name of the FWD but launches no due dates for the FWD. In other words, if the received FWD is determined to be older than a threshold or otherwise marked as “inactive,” the document is inserted into the existing IP docketing system without generation of any due dates. A single generic template can do this, but the name of the template may be changed to the bookmark title of the FWD to match the name of the FWD. The contents of the FWD may be dropped into the file, which saves the human operator from having to close out fake dates. On the other hand, if the received FWD is determined at 1710 to be “active,” then it is mapped at 1730 to a docketing template of the existing IP docketing system that is normally used to docket that item to generate cascading activities based on receipt of the FWD. For example, if the FWD is a FOAR (final office action received), then the appropriate due dates are generated from the mail date of the FOAR. This docketing template will receive the date from the FWD and may use the date as the mailing date. The process ends at 1740 and the mapped FWD is further processed by the IP docketing system. Also, as desired, the mapped FWD may also be annotated as described in detail above.

It will be appreciated by those skilled in the art that the automated docketing system described herein uses scripts and machine learning techniques to increase the efficiency of the docketing process by automating the docketing of intellectual property file documents into an IP docketing system with little or no human intervention and prescribing subsequent processing of the received documents. It will be appreciated that such techniques may be adapted to download, annotate, and docket trademark and copyright documents from corresponding government websites and also may be adapted to download, annotate, and docket other legal documents such as litigation documents from government litigation tracking websites such as PACER. In such as case, the “file wrapper” may include a number of entries into a litigation docket maintain by the litigation tracking website.

### Computer Embodiment

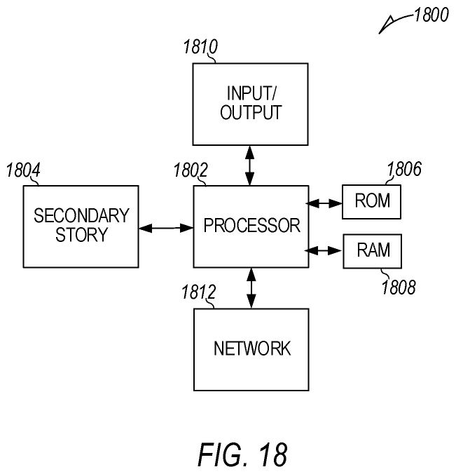

FIG. 18 is a block diagram of a typical, general-purpose computer 1800 that may be programmed into a special purpose computer suitable for implementing one or more embodiments of the automated docketing system disclosed herein. The automated docketing system described above may be implemented on any general-purpose processing component, such as a computer with sufficient processing power, memory resources, and communications throughput capability to handle the workload placed upon it. The computer 1800 includes a processor 1802 (which may be referred to as a central processor unit or CPU) that is in communication with memory devices including secondary storage 1804, read only memory (ROM) 1806, random access memory (RAM) 1808, input/output (I/O) devices 1810, and network connectivity devices 1812. The processor 1802 may be implemented as one or more CPU chips or may be part of one or more application specific integrated circuits (ASICs).

The secondary storage 1804 is typically comprised of one or more disk drives or tape drives and is used for non-volatile storage of data and as an over-flow data storage device if RAM 1808 is not large enough to hold all working data. Secondary storage 1804 may be used to store programs that are loaded into RAM 1808 when such programs are selected for execution. The ROM 1806 is used to store instructions and perhaps data that are read during program execution. ROM 1806 is a non-volatile memory device that typically has a small memory capacity relative to the larger memory capacity of secondary storage 1804. The RAM 1808 is used to store volatile data and perhaps to store instructions. Access to both ROM 1806 and RAM 1808 is typically faster than to secondary storage 1804.

The devices described herein may be configured to include computer-readable non-transitory media storing computer readable instructions and one or more processors coupled to the memory, and when executing the computer readable instructions configure the computer 1800 to perform method steps and operations described above with reference to FIG. 1 to FIG. 17. The computer-readable non-transitory media includes all types of computer readable media, including magnetic storage media, optical storage media, flash media and solid-state storage media.

It should be further understood that software including one or more computer-executable instructions that facilitate processing and operations as described above with reference to any one or all of steps of the disclosure may be installed in and sold with one or more servers and/or one or more routers and/or one or more devices within consumer and/or producer domains consistent with the disclosure. Alternatively, the software may be obtained and loaded into one or more servers and/or one or more routers and/or one or more devices within consumer and/or producer domains consistent with the disclosure, including obtaining the software through physical medium or distribution system, including, for example, from a server owned by the software creator or from a server not owned but used by the software creator. The software may be stored on a server for distribution over the Internet, for example.

Also, it will be understood by one skilled in the art that this disclosure is not limited in its application to the details of construction and the arrangement of components set forth in the description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, terms such as up, down, bottom, and top are relative, and are employed to aid illustration, but are not limiting.

The components of the illustrative devices, systems and methods employed in accordance with the illustrated embodiments may be implemented, at least in part, in digital electronic circuitry, analog electronic circuitry, or in computer hardware, firmware, software, or in combinations of them. These components may be implemented, for example, as a computing program product such as a computing program, program code or computer instructions tangibly embodied in an information carrier, or in a machine-readable storage device, for execution by, or to control the operation of, data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. A computing program may be deployed to be executed on one computer or on multiple computers at one site or distributed across multiple sites and interconnected by a communication network. Also, functional programs, codes, and code segments for accomplishing the techniques described herein may be easily construed as within the scope of the present disclosure by programmers skilled in the art. Method steps associated with the illustrative embodiments may be performed by one or more programmable processors executing a computing program, code or instructions to perform functions (e.g., by operating on input data and/or generating an output). Method steps may also be performed by, and apparatus may be implemented as, special purpose logic circuitry, e.g., an FPGA (field programmable gate array) or an ASIC (application-specific integrated circuit), for example.

The various illustrative logical blocks, modules, and circuits described in connection with the embodiments disclosed herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computing program include, by way of example, both general and special purpose microprocessors, and any one or more processors of any kind of digital computer. Generally, a processor will receive instructions and data from a read-only memory or a random-access memory or both. The main elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computing program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory may be supplemented by or incorporated in special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. In other words, the processor and the storage medium may reside in an integrated circuit or be implemented as discrete components.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, that is capable of storing instructions for execution by one or more processors, such that the instructions, when executed by one or more processors cause the one or more processors to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” as used herein excludes signals per se.

### Examples

In addition to the claimed systems and methods, the examples further include:

Example 1 is a computer-implemented method of docketing documents relating to legal matters, comprising: receiving, by at least one processor, from third party sources documents relating to one or more legal matters; performing, by the at least one processor, Optical Character Recognition (OCR) on at least one of the received documents and extracting identification data that relates to a document type; annotating, by the at least one processor, the at least one document to provide metadata about contents of the at least one document that may be used to identify the at least one document and to docket the at least one document in a docketing system; extracting, by the at least one processor, annotations from the at least one document to complete an automated processing template including universal procedure codes for the at least one document that specify any processes to be performed on the at least one document upon receipt by the docketing system; and forwarding, by the at least one processor, the at least one document and the automated processing template to the docketing system.

Example 2 is a method as in Example 1, where annotating the at least one document comprises attaching a key-value pair relating to data within the at least one document.

Example 3 is a method as in any preceding Example, further comprising automatically processing the at least one document based on pre-established automated procedures for respective annotations.

Example 4 is a method as in any preceding Example, wherein automatically processing the at least one document comprises performing universal procedures for the at least one document once identified that are supplemented by customer-specific procedures that are unique to a given customer.

Example 5 is a method as in any preceding Example, wherein the annotations specify at least one of a response due date, whether an Official Action is final or non-final, and whether drawing corrections are needed.

Example 6 is a method as in any preceding Example, wherein receiving from third party sources documents relating to one or more legal matters comprises receiving documents from at least one of a Patent Office docketing portal, Patent Office Patent Application Information Retrieval (PAIR) files, and via email from a foreign agent, a law firm, or a corporate law department.

Example 7 is a method as in any preceding Example, wherein performing OCR on at least one of the received documents and extracting identification data that relates to the document type comprises at least one of extracting specified data, reading checkboxes, and extracting lists from the at least one received document.

Example 8 is a method as in any preceding Example, wherein completing the automated processing template comprises pulling in attributes from the annotations in the at least one document.

Example 9 is a method as in any preceding Example, wherein forwarding the at least one document and the automated processing template to the docketing system comprises validating received documents against entries in the docketing system and communicating validated documents to the docketing system.

Example 10 is a method as in any preceding Example, further comprising sending a docketing report to an external verification system that uses a set of annotation rules to verify proper docketing in the docketing system.

Example 11 is a method as in any preceding Example, further comprising automatically generating an automated email notification that specifies docketing processes taken on the identified document.

Example 12 is a method as in any preceding Example, wherein annotating the at least one document to provide metadata about the contents of the at least one document comprises generating annotations using a machine learning system that has been trained using a training set comprising prior document identification data.

Example 13 is a method as in any preceding Example, further comprising processing the received at least one document into one or more documents in portable document format (PDFs), inserting the one or more PDFs into a zip file, and forwarding the zip file to an OCR system to extract text and annotations from the at least one document that may be used to identify the at least one document.

Example 14 is a method as in any preceding Example, wherein identifying the at least one document comprises comparing a string match extracted during OCR with identifying data for identifying the at least one document.

Example 15 is a method as in any preceding Example, wherein when the at least one document has a string match with identifying data for more than one document type, annotation rules and verification rules are applied to the at least one document and the annotations to uniquely identify the document type.

Example 16 is a method as in any preceding Example, wherein extracting identification data that relates to the document type comprises applying text extraction rules to text data generated by performing OCR on the at least one received document to extract the identification data relating to the document type.

Example 17 is a method as in any preceding Example, wherein extracting identification data comprises identifying checkboxes, form numbers, and phrases in the at least one received document.

Example 18 is a method as in any preceding Example, wherein identifying the at least one document comprises pre-verifying the at least one document using Multidoc rules by reading the at least one document as well as any documents to which the at least one document is associated in a zip file to select phrases and to perform identification of the at least one document.

Example 19 is a method as in any preceding Example, wherein identifying the at least one document comprises downloading a unified rules file that provides a set of rules for how to identify and verify a document with a unique document item ID (UDOCIID), matching the at least one document against the unified rules to identify a UDOCIID for the at least one document and any associated annotations, and identifying the at least one document from the UDOCIIDs.

Example 20 is a method as in any preceding Example, wherein identifying the at least one document comprises applying phrase rules that generate a single query that refers to different parts of the at least one document and using Boolean logic and regular expressions to provide a UDOCIID for the at least one document where each individual element in a phrase rule evaluates to true or false.

Example 21 is a method as in any preceding Example, wherein annotating the at least one document to provide metadata about the contents of the at least one document comprises searching results of the OCR for particular text.

Example 22 is a method as in any preceding Example, wherein annotating the at least one document to provide metadata about the contents of the at least one document comprises calculating dates out of an image file wrapper XML and determining if the at least one document was received within a predetermined number of days of a particular event.

Example 23 is a method as in any preceding Example, wherein annotating the at least one document to provide metadata about the contents of the at least one document comprises generating annotations through functions that fail immediately when the at least one document is not from a particular country or the function does not have sufficient information to calculate the annotation but that add a new annotation to the at least one document when the function succeeds.

Example 24 is a method as in any preceding Example, further comprising sending the at least document once identified by document type back through a specialized OCR function built specifically to extract annotations for the document type of the at least one document.

Example 25 is a method as in any preceding Example, further comprising testing identification of the at least one document by using a machine learning system to predict an identification of the at least one document, comparing the predicted identification to the identification determined from the annotations, and accepting the identification of the at least one document when the predicted identification is consistent with the identification determined from the annotations.

Example 26 is a method as in any preceding Example, further comprising using a machine learning system to predict a next docket process from particular text in the at least one document that corresponds to a particular procedure code and docketing the at least one document according to the procedure code.

Example 27 is a method as in any preceding Example, wherein forwarding the at least one document and the automated processing template to the docketing system comprises sending the at least one document to a human docketer for making a docketing selection and verifying the docketing selection using a machine learning system that determines a machine learning score from the extracted annotations, the machine learning score representing a percentage likelihood that an applied docketing selection is a correct choice for a document.

Example 28 is a method as in any preceding Example, wherein the docketing selection by the human docketer is forwarded to the docketing system when the machine learning score has at least a minimum value.

Example 29 is a method as in any preceding Example, wherein a warning is provided to the human docketer when the machine learning score is below a minimum value.

Example 30 is a method as in any preceding Example, wherein forwarding the at least one document and the automated processing template to the docketing system comprises creating a reporting template, auto-filling the reporting template with data relating to a docketing process to be taken for the at least one document, and forwarding the reporting template to the docketing system.

Example 31 is a method as in any preceding Example, wherein annotating the at least one document comprises applying annotation rules.

Example 32 is a method as in any preceding Example, wherein applying the annotation rules comprises using the annotation rules to fetch publicly accessible data upon which docketing decisions for a document and logic for the annotation rules may be based.

Example 33 is a method as in any preceding Example, further comprising writing the annotation rules based on historical events for one or more particular type of document.

Example 34 is a method as in any preceding Example, further comprising writing the annotation rules based on metadata about the contents of the at least one document.

Example 35 is a method as in any preceding Example, further comprising providing version control and version integrity for the annotation rules.

Example 36 is a method as in any preceding Example, wherein the annotation rules are recursive, further comprising applying annotation rules that set annotations before applying annotation rules that rely upon the set annotations.

Example 37 is a method as in any preceding Example, further comprising identifying the at least one document using a single identifier that represents multiple associated documents.

Example 38 is a method as in any preceding Example, wherein the annotation rules specify that at least one of a document identification and a procedure code for processing a document may not be assigned more than once in a given time period.

Example 39 is a method as in any preceding Example, wherein forwarding the at least one document and the automated processing template to the docketing system comprises sending the at least one document to the docketing system and automatically forwarding the at least one document to at least one of a designated email address and a folder of a client of the docketing system.

Example 40 is a method as in any preceding Example, further comprising associating a message to a human docketer with each annotation rule and presenting the message to the human docketer when the annotation rule is invoked.

Example 41 is a method as in any preceding Example, further comprising: scraping, by the at least one processor, at least one web site of a third party source having docket items relating to the one or more legal matters; downloading and storing, by the at least one processor, scraped docket items in a database; and providing, by the at least one processor, a scraped docket item as the at least one document for annotation.

Example 42 is a method as in any preceding Example, further comprising cross-referencing a docket item stored in the database against received communications, joining the docket item to a received communication that is matched to the docket item, and providing the joined docket item and received communication for annotation.

Example 43 is a method as in any preceding Example, further comprising: scraping, by the at least one processor, at least one web site of a third party source having docket items relating to the one or more legal matters; downloading and storing, by the at least one processor, scraped docket items in a database; enabling, by the at least one processor, access to stored docket item associated with a portfolio; and generating, by the at least one processor, a reporting letter having at least one of a link to or an attached copy of the stored docket item.

Example 44 is a method as in any preceding Example, wherein scraping the at least one web site of a third party source comprises a scraper tool changing its Internet Protocol (IP) address and user agent periodically to change its identity between scrapes and reshuffling the IP addresses and user agents for use in subsequent scrapes after a predetermined number of identities has been used.

Example 45 is a method as in any preceding Example, wherein receiving documents relating to one or more legal matters comprises downloading a file wrapper as a consolidated document in portable document format (PDF).

Example 46 is a method as in any preceding Example, further comprising breaking out respective documents from the file wrapper by assigning a bookmark in PDF to each separate individual file wrapper document in the file wrapper, extracting each individual file wrapper document from the consolidated PDF, and assigning to each extracted file wrapper document at least one of a file name or metadata.

Example 47 is a method as in any preceding Example, wherein the at least one file name or metadata includes at least one of a date of the extracted file wrapper document, a serial number of the file wrapper, or name assigned to the extracted file wrapper document by a third party source of the file wrapper.

Example 48 is a method as in any preceding Example, further comprising tagging the extracted file wrapper document with a tag describing contents of the extracted file wrapper document.

Example 49 is a method as in any preceding Example, further comprising determining whether the extracted file wrapper document is from a pending matter and, when the extracted file wrapper document is determined to be from a pending matter, tagging the extracted file wrapper document as active; otherwise tagging the extracted file wrapper document as inactive.

Example 50 is a method as in any preceding Example, further comprising mapping the extracted file wrapper document to a docketing template that loads an activity with a date and a name of the extracted file wrapper document but launches no due dates for the extracted file wrapper document, when the received file wrapper document is determined to be inactive.

Example 51 is a method as in any preceding Example, further comprising mapping the extracted file wrapper document to a docketing template that is used to docket documents of a type of the extracted file wrapper document in the docketing system, when the received file wrapper document is determined to be active.

Example 52 is a computer-implemented method of docketing documents relating to legal matters, comprising: downloading, using at least one processor, from a third party website a file wrapper as a consolidated document in portable document format (PDF); breaking out, using the at least one processor, respective documents from the file wrapper by assigning a bookmark in PDF to each separate individual file wrapper document in the file wrapper, extracting each individual file wrapper document from the consolidated PDF, and assigning to each extracted file wrapper document at least one of a file name or metadata; tagging, using the at least one processor, the extracted file wrapper document with a tag describing contents of the extracted file wrapper document; determining, using the at least one processor, whether the extracted file wrapper document is from a pending matter; when the extracted file wrapper document is determined to be from a pending matter, tagging, using the at least one processor, the extracted file wrapper document as active; when the extracted file wrapper document is determined not to be from a pending matter, tagging, using the at least one processor, the extracted file wrapper document as inactive; and forwarding, by the at least one processor, the extracted file wrapper document to a docketing system.

Example 53 is a method as in Example 52, further comprising mapping the extracted file wrapper document to a docketing template that loads an activity with a date and a name of the extracted file wrapper document but launches no due dates for the extracted file wrapper document, when the received file wrapper document is determined to be inactive.

Example 54 is a method as in Examples 52 or 53, further comprising mapping the extracted file wrapper document to a docketing template that is used to docket documents of a type of the extracted file wrapper document in the docketing system, when the received file wrapper document is determined to be active.

Example 55 is an automated docketing system, comprising: at least one processor; and a memory that stores instructions, wherein the instructions, when executed by the at least one processor, configure the at least one processor to docket documents relating to legal matters by performing operations comprising: receiving from third party sources documents relating to one or more legal matters; performing Optical Character Recognition (OCR) on at least one of the received documents and extracting identification data that relates to a document type; annotating the at least one document to provide metadata about contents of the at least one document that may be used to identify the at least one document and to docket the at least one document; extracting annotations from the at least one document to complete an automated processing template including universal procedure codes for the at least one document that specify any processes to be performed on the at least one document upon receipt; and forwarding the at least one document and the automated processing template for further processing.

Example 56 is a system as in Example 55, where the instructions for annotating the at least one document comprises instructions for attaching a key-value pair relating to data within the at least one document.

Example 57 is a system as in Examples 55 or 56, further comprising instructions that when executed by the at least one processor automatically process the at least one document based on pre-established automated procedures for respective annotations.

Example 58 is a system as in Examples 55-57, wherein the instructions for automatically processing the at least one document comprises instructions for performing universal procedures for the at least one document once identified that are supplemented by customer-specific procedures that are unique to a given customer.

Example 59 is a system as in Examples 55-58, wherein the annotations specify at least one of a response due date, whether an Official Action is final or non-final, and whether drawing corrections are needed.

Example 60 is a system as in Examples 55-59, wherein the instructions for receiving from third party sources documents relating to one or more legal matters comprises instructions for receiving documents from at least one of a Patent Office docketing portal, Patent Office Patent Application Information Retrieval (PAIR) files, and via email from a foreign agent, a law firm, or a corporate law department.

Example 61 is a system as in Examples 55-60, wherein the instructions for performing OCR on at least one of the received documents and extracting identification data that relates to the document type comprises instructions for at least one of extracting specified data, reading checkboxes, and extracting lists from the at least one received document.

Example 62 is a system as in Examples 55-61, wherein the instructions for completing the automated processing template comprises instructions for pulling in attributes from the annotations in the at least one document.

Example 63 is a system as in Examples 55-62, wherein the instructions for forwarding the at least one document and the automated processing template to the docketing system comprises instructions for validating received documents against entries in the docketing system and instructions for communicating validated documents to the docketing system.

Example 64 is a system as in Examples 55-63, further comprising instructions for sending a docketing report to an external verification system that uses a set of annotation rules to verify proper docketing in the docketing system.

Example 65 is a system as in Examples 55-64, further comprising instructions for automatically generating an automated email notification that specifies docketing processes taken on the identified document.

Example 66 is a system as in Examples 55-65, wherein the instructions for annotating the at least one document to provide metadata about the contents of the at least one document comprises instructions for generating annotations using a machine learning system that has been trained using a training set comprising prior document identification data.

Example 67 is a system as in Examples 55-66, further comprising instructions processing the received at least one document into one or more documents in portable document format (PDFs), instructions for inserting the one or more PDFs into a zip file, and instructions for forwarding the zip file to an OCR system to extract text and annotations from the at least one document that may be used to identify the at least one document.

Example 68 is a system as in Examples 55-67, wherein the instructions for identifying the at least one document comprises instructions for comparing a string match extracted during OCR with identifying data for identifying the at least one document.

Example 69 is a system as in Examples 55-68, further comprising instructions for applying annotation rules and verification rules to the at least one document and the annotations to uniquely identify the document type when the at least one document has a string match with identifying data for more than one document type.

Example 70 is a system as in Examples 55-69, wherein the instructions for extracting identification data that relates to the document type comprises instructions for applying text extraction rules to text data generated by performing OCR on the at least one received document to extract the identification data relating to the document type.

Example 71 is a system as in Examples 55-70, wherein the instructions for extracting identification data comprises instructions for identifying checkboxes, form numbers, and phrases in the at least one received document.

Example 72 is a system as in Examples 55-71, wherein the instructions for identifying the at least one document comprises instructions for pre-verifying the at least one document using Multidoc rules by reading the at least one document as well as any documents to which the at least one document is associated in a zip file to select phrases and to perform identification of the at least one document.

Example 73 is a system as in Examples 55-72, wherein the instructions for identifying the at least one document comprises instructions for downloading a unified rules file that provides a set of rules for how to identify and verify a document with a unique document item ID (UDOCIID), instructions for matching the at least one document against the unified rules to identify a UDOCIID for the at least one document and any associated annotations, and instructions for identifying the at least one document from the UDOCIIDs.

Example 74 is a system as in Examples 55-73, wherein the instructions for identifying the at least one document comprises instructions for applying phrase rules that generate a single query that refers to different parts of the at least one document and instructions for using Boolean logic and regular expressions to provide a UDOCIID for the at least one document where each individual element in a phrase rule evaluates to true or false.

Example 75 is a system as in Examples 55-74, wherein the instructions for annotating the at least one document to provide metadata about the contents of the at least one document comprises instructions for searching results of the OCR for particular text.

Example 76 is a system as in Examples 55-75, wherein the instructions for annotating the at least one document to provide metadata about the contents of the at least one document comprises instructions for calculating dates out of an image file wrapper XML, and instructions for determining if the at least one document was received within a predetermined number of days of a particular event.

Example 77 is a system as in Examples 55-76, wherein the instructions for annotating the at least one document to provide metadata about the contents of the at least one document comprises instructions for generating annotations through functions that fail immediately when the at least one document is not from a particular country or the function does not have sufficient information to calculate the annotation but that add a new annotation to the at least one document when the function succeeds.

Example 78 is a system as in Examples 55-77, further comprising instructions for sending the at least document once identified by document type back through a specialized OCR function built specifically to extract annotations for the document type of the at least one document.

Example 79 is a system as in Examples 55-78, further comprising instructions for testing identification of the at least one document by using a machine learning system to predict an identification of the at least one document, instructions for comparing the predicted identification to the identification determined from the annotations, and instructions for accepting the identification of the at least one document when the predicted identification is consistent with the identification determined from the annotations.

Example 80 is a system as in Examples 55-79, further comprising instructions for using a machine learning system to predict a next docket process from particular text in the at least one document that corresponds to a particular procedure code and instructions for docketing the at least one document according to the procedure code.

Example 81 is a system as in Examples 55-80, wherein the instructions for forwarding the at least one document and the automated processing template to the docketing system comprises instructions for sending the at least one document to a human docketer for making a docketing selection and instructions for verifying the docketing selection using a machine learning system that determines a machine learning score from the extracted annotations, the machine learning score representing a percentage likelihood that an applied docketing selection is a correct choice for a document.

Example 82 is a system as in Examples 55-81, further comprising instructions for forwarding the docketing selection by the human docketer to the docketing system when the machine learning score has at least a minimum value.

Example 83 is a system as in Examples 55-82, further comprising instructions for providing a warning to the human docketer when the machine learning score is below a minimum value.

Example 84 is a system as in Examples 55-83, wherein the instructions for forwarding the at least one document and the automated processing template to the docketing system comprises instructions for creating a reporting template, instructions for auto-filling the reporting template with data relating to a docketing process to be taken for the at least one document, and instructions for forwarding the reporting template to the docketing system.

Example 85 is a system as in Examples 55-84, wherein the instructions for annotating the at least one document comprises instructions for applying annotation rules.

Example 86 is a system as in Examples 55-85, wherein the instructions for applying the annotation rules comprises instructions for using the annotation rules to fetch publicly accessible data upon which docketing decisions for a document and logic for the annotation rules may be based.

Example 87 is a system as in Examples 55-86, further comprising instructions for writing the annotation rules based on historical events for one or more particular type of document.

Example 88 is a system as in Examples 55-87, further comprising instructions for writing the annotation rules based on metadata about the contents of the at least one document.

Example 89 is a system as in Examples 55-88, further comprising instructions for providing version control and version integrity for the annotation rules.

Example 90 is a system as in Examples 55-89, wherein the annotation rules are recursive, further comprising instructions for applying annotation rules that set annotations before applying annotation rules that rely upon the set annotations.

Example 91 is a system as in Examples 55-90, further comprising instructions for identifying the at least one document using a single identifier that represents multiple associated documents.

Example 92 is a system as in Examples 55-91, wherein the annotation rules specify that at least one of a document identification and a procedure code for processing a document may not be assigned more than once in a given time period.

Example 93 is a system as in Examples 55-92, wherein the instructions for forwarding the at least one document and the automated processing template to the docketing system comprises instructions for sending the at least one document to the docketing system and instructions for automatically forwarding the at least one document to at least one of a designated email address and a folder of a client of the docketing system.

Example 94 is a system as in Examples 55-93, further comprising instructions for associating a message to a human docketer with each annotation rule and instructions for presenting the message to the human docketer when the annotation rule is invoked.

Example 95 is a system as in Examples 55-94, further comprising instructions for scraping at least one website of a third party source having docket items relating to the one or more legal matters, instructions for downloading and storing scraped docket items in a database, and instructions for providing a scraped docket item as the at least one document for annotation.

Example 96 is a system as in Examples 55-95, further comprising instructions for cross-referencing a docket item stored in the database against received communications, instructions for joining the docket item to a received communication that is matched to the docket item, and instructions for providing the joined docket item and received communication for annotation.

Example 97 is a system as in Examples 55-96, further comprising instructions for scraping at least one website of a third party source having docket items relating to the one or more legal matters, instructions for downloading and storing scraped docket items in a database, instructions for enabling access to stored docket item associated with a portfolio, and instructions for generating a reporting letter having at least one of a link to or an attached copy of the stored docket item.

Example 98 is a system as in Examples 55-97, further comprising a scraper tool that changes its Internet Protocol (IP) address and user agent periodically to change its identity between scrapes, further comprising instructions for reshuffling the IP addresses and user agents for use in subsequent scrapes after a predetermined number of identities has been used.

Example 99 is a system as in Examples 55-98, wherein the instructions for receiving documents relating to one or more legal matters comprises instructions for downloading a file wrapper as a consolidated document in portable document format (PDF).

Example 100 is a system as in Examples 55-99, further comprising instructions for breaking out respective documents from the file wrapper by assigning a bookmark in PDF to each separate individual file wrapper document in the file wrapper, extracting each individual file wrapper document from the consolidated PDF, and assigning to each extracted file wrapper document at least one of a file name or metadata.

Example 101 is a system as in Examples 55-100, wherein the at least one file name or metadata includes at least one of a date of the extracted file wrapper document, a serial number of the file wrapper, or name assigned to the extracted file wrapper document by a third party source of the file wrapper.

Example 102 is a system as in Examples 55-101, further comprising instructions for tagging the extracted file wrapper document with a tag describing contents of the extracted file wrapper document.

Example 103 is a system as in Examples 55-102, further comprising instructions for determining whether the extracted file wrapper document is from a pending matter and, when the extracted file wrapper document is determined to be from a pending matter, tagging the extracted file wrapper document as active; otherwise tagging the extracted file wrapper document as inactive.

Example 104 is a system as in Examples 55-103, further comprising instructions for mapping the extracted file wrapper document to a docketing template that loads an activity with a date and a name of the extracted file wrapper document but launches no due dates for the extracted file wrapper document, when the received file wrapper document is determined to be inactive.

Example 105 is a system as in Examples 55-104, further comprising instructions for mapping the extracted file wrapper document to a docketing template that is used to docket documents of a type of the extracted file wrapper document in the docketing system, when the received file wrapper document is determined to be active.

Example 106 is an automated docketing system, comprising: at least one processor; and a memory that stores instructions, wherein the instructions, when executed by the at least one processor, configure the at least one processor to docket documents relating to legal matters by performing operations comprising: downloading from a third party website a file wrapper as a consolidated document in portable document format (PDF); breaking out respective documents from the file wrapper by assigning a bookmark in PDF to each separate individual file wrapper document in the file wrapper, extracting each individual file wrapper document from the consolidated PDF, and assigning to each extracted file wrapper document at least one of a file name or metadata; tagging the extracted file wrapper document with a tag describing contents of the extracted file wrapper document; determining whether the extracted file wrapper document is from a pending matter; when the extracted file wrapper document is determined to be from a pending matter, tagging the extracted file wrapper document as active; when the extracted file wrapper document is determined not to be from a pending matter, tagging the extracted file wrapper document as inactive; and forwarding the extracted file wrapper document for further processing.

Example 107 is a system as in Example 106, further comprising instructions for mapping the extracted file wrapper document to a docketing template that loads an activity with a date and a name of the extracted file wrapper document but launches no due dates for the extracted file wrapper document, when the received file wrapper document is determined to be inactive.

Example 108 is a system as in Examples 106 or 107, further comprising instructions for mapping the extracted file wrapper document to a docketing template that is used to docket documents of a type of the extracted file wrapper document in the docketing system, when the received file wrapper document is determined to be active.

Example 109 is non-transitory computer readable medium having instructions stored thereon that when executed by one or more processors implements a method of docketing documents relating to legal matters, comprising: instructions for receiving from third party sources documents relating to one or more legal matters; instructions for performing Optical Character Recognition (OCR) on at least one of the received documents and extracting identification data that relates to a document type; instructions for annotating the at least one document to provide metadata about contents of the at least one document that may be used to identify the at least one document and to docket the at least one document in a docketing system; instructions for extracting annotations from the at least one document to complete an automated processing template including universal procedure codes for the at least one document that specify any processes to be performed on the at least one document upon receipt by the docketing system; and instructions for forwarding the at least one document and the automated processing template to the docketing system.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention may be determined with reference to the appended claims, along with the full scope of equivalents to which such claims are entitled.

1. A method of docketing documents relating to legal matters, comprising:
receiving, by at least one processor, from third party sources documents relating to one or more legal matters;
performing, by the at least one processor, Optical Character Recognition (OCR) on at least one of the received documents and extracting identification data that relates to a document type;
annotating, by the at least one processor, the at least one document to provide metadata about contents of the at least one document that may be used to identify the at least one document and to docket the at least one document in a docketing system;
extracting, by the at least one processor, annotations from the at least one document to complete an automated processing template including universal procedure codes for the at least one document that specify any processes to be performed on the at least one document upon receipt by the docketing system; and
forwarding, by the at least one processor, the at least one document and the automated processing template to the docketing system.

2. A method as in claim 1, where annotating the at least one document comprises attaching a key-value pair relating to data within the at least one document.

3. A method as in claim 1, further comprising automatically processing the at least one document based on pre-established automated procedures for respective annotations.

4. A method as in claim 3, wherein automatically processing the at least one document comprises performing universal procedures for the at least one document once identified that are supplemented by customer-specific procedures that are unique to a given customer.

5. A method as in claim 1, wherein receiving from third party sources documents relating to one or more legal matters comprises receiving documents from at least one of a Patent Office docketing portal, Patent Office Patent Application Information Retrieval (PAIR) files, and via email from a foreign agent, a law firm, or a corporate law department.

6. A method as in claim 1, wherein forwarding the at least one document and the automated processing template to the docketing system comprises validating received documents against entries in the docketing system and communicating validated documents to the docketing system.

7. A method as in claim 1, further comprising sending a docketing report to an external verification system that uses a set of annotation rules to verify proper docketing in the docketing system.

8. A method as in claim 1, further comprising automatically generating an automated email notification that specifies docketing processes taken on the identified document.

9. A method as in claim 1, wherein identifying the at least one document comprises pre-verifying the at least one document using Multidoc rules by reading the at least one document as well as any documents to which the at least one document is associated in a zip file to select phrases and to perform identification of the at least one document.

10. A method as in claim 1, wherein identifying the at least one document comprises downloading a unified rules file that provides a set of rules for how to identify and verify a document with a unique document item ID (UDOCIID), matching the at least one document against the unified rules to identify a UDOCIID for the at least one document and any associated annotations, and identifying the at least one document from the UDOCIIDs.

11. A method as in claim 1, wherein annotating the at least one document to provide metadata about the contents of the at least one document comprises calculating dates out of an image file wrapper XML, and determining if the at least one document was received within a predetermined number of days of a particular event.

12. A method as in claim 1, further comprising testing identification of the at least one document by using a machine learning system to predict an identification of the at least one document, comparing the predicted identification to the identification determined from the annotations, and accepting the identification of the at least one document when the predicted identification is consistent with the identification determined from the annotations.

13. A method as in claim 1, wherein forwarding the at least one document and the automated processing template to the docketing system comprises creating a reporting template, auto-filling the reporting template with data relating to a docketing process to be taken for the at least one document, and forwarding the reporting template to the docketing system.

14. A method as in claim 1, further comprising:
scraping, by the at least one processor, at least one website of a third party source having docket items relating to the one or more legal matters;
downloading and storing, by the at least one processor, scraped docket items in a database; and
providing, by the at least one processor, a scraped docket item as the at least one document for annotation.

15. A method as in claim 14, further comprising:
scraping, by the at least one processor, at least one web site of a third party source having docket items relating to the one or more legal matters;
downloading and storing, by the at least one processor, scraped docket items in a database;
enabling, by the at least one processor, access to stored docket item associated with a portfolio; and
generating, by the at least one processor, a reporting letter having at least one of a link to or an attached copy of the stored docket item.

16. A method as in claim 14, wherein scraping the at least one website of a third party source comprises a scraper tool changing its Internet Protocol (IP) address and user agent periodically to change its identity between scrapes and reshuffling the IP addresses and user agents for use in subsequent scrapes after a predetermined number of identities has been used.

17. A method as in claim 1, wherein receiving documents relating to one or more legal matters comprises downloading a file wrapper as a consolidated document in portable document format (PDF), further comprising breaking out respective documents from the file wrapper by assigning a bookmark in PDF to each separate individual file wrapper document in the file wrapper, extracting each individual file wrapper document from the consolidated PDF, and assigning to each extracted file wrapper document at least one of a file name or metadata.

18. An automated docketing system, comprising:
at least one processor; and
a memory that stores instructions, wherein the instructions, when executed by the at least one processor, configure the at least one processor to docket documents relating to legal matters by performing operations comprising:
receiving from third party sources documents relating to one or more legal matters;
performing Optical Character Recognition (OCR) on at least one of the received documents and extracting identification data that relates to a document type;
annotating the at least one document to provide metadata about contents of the at least one document that may be used to identify the at least one document and to docket the at least one document;
extracting annotations from the at least one document to complete an automated processing template including universal procedure codes for the at least one document that specify any processes to be performed on the at least one document upon receipt; and
forwarding the at least one document and the automated processing template for further processing.

19. An automated docketing system as in claim 18, wherein the memory comprises further instructions that, when executed by the at least one processor, further configure the at least one processor to perform operations comprising:
scraping at least one web site of a third party source having docket items relating to the one or more legal matters;
downloading and storing scraped docket items in a database; and
providing a scraped docket item as the at least one document for annotation.

20. A non-transitory computer readable medium having instructions stored thereon that when executed by one or more processors implements a method of docketing documents relating to legal matters, comprising:
instructions for receiving from third party sources documents relating to one or more legal matters;
instructions for performing Optical Character Recognition (OCR) on at least one of the received documents and extracting identification data that relates to a document type;
instructions for annotating the at least one document to provide metadata about contents of the at least one document that may be used to identify the at least one document and to docket the at least one document in a docketing system;
instructions for extracting annotations from the at least one document to complete an automated processing template including universal procedure codes for the at least one document that specify any processes to be performed on the at least one document upon receipt by the docketing system; and
instructions for forwarding the at least one document and the automated processing template to the docketing system.
